(19) United States
(12) Patent Application Publication
(10) Pub. No.: US 2016/0350133 A1
(43) Pub. Date: Dec. 1, 2016

(54) INFORMATION PROCESSING APPARATUS AND ELECTRONIC EQUIPMENT

(71) Applicant: FUJITSU LIMITED, Kawasaki-shi (JP)

(72) Inventors: Tomoharu Imai, Kawasaki (JP); Koichi Yamasaki, Kawasaki (JP); Ryo Miyamoto, Kawasaki (JP); Kenichi Horio, Yokohama (JP); Kazuki Matsui, Kawasaki (JP); Masahiro MATSUDA, Yokohama (JP)

(73) Assignee: FUJITSU LIMITED, Kawasaki-shi (JP)

(21) Appl. No.: 15/094,294

(22) Filed: Apr. 8, 2016

(30) Foreign Application Priority Data
May 25, 2015 (JP) 2015-105823

(51) Int. Cl. G06F 9/44

(52) U.S. Cl. CPC G06F 9/4443

(57) ABSTRACT

An information processing apparatus includes a processor configured to extract one or more processing codes describing a screen of the program by analyzing processing codes in a program, to generate a processing code group for screen processing by combining one or more extracted processing codes in a manner of being executable by an electronic equipment, to transmit the processing code group for the screen processing to the electronic equipment, to execute the processing codes excluding the processing code group for the screen processing in the program upon accepting a processing requests from the one or more extracted processing codes contained in the processing code group for the screen processing executed by the electronic equipment, and to transmit execution results of the processing codes, associated with the processing requests, in the program to the electronic equipment.

### CROSS-REFERENCE TO RELATED APPLICATION

This application is based upon and claims the benefit of priority of the prior Japanese Patent Application No. 2015-105823, filed on May 25, 2015, the entire contents of which are incorporated herein by reference.

### FIELD

The embodiments discussed herein are related to an information processing apparatus and an electronic equipment.

### BACKGROUND

Over the recent years, with spreads of information processing terminals instanced by smartphones, notebook PCs (Personal Computers), tablet PCs and PDAs (Personal Data Assistants) and with a speed-up of mobile communication environment, there has been a tendency of increasing utilization of services of the information processing terminals under the mobile environment. The information processing terminal (which will hereinafter be also termed an electronic equipment) has a tendency of being installed with a mobile application program (which will hereinafter be simply referred to as the mobile application) executed by using OS (Operating System) preinstalled in the information processing terminal. The information processing terminal in recent years is enabled to utilize the services in cooperation with wearable equipments instanced by a smartglass usable by being fitted to a head in a manner of wearing eyeglasses, and a smartwatch (wristband) information processing equipment/sensor.

Note that the following documents, which describe technologies pertaining to a technology discussed in the present specification, of the prior arts exist.

[Patent document 1] Japanese Laid-Open Patent Publication No. 2006-197601

### SUMMARY

According to an aspect of the embodiments, an information processing apparatus includes a processor configured to extract one or more processing codes describing a screen of the program by analyzing processing codes in a program, to generate a processing code group for screen processing by combining one or more extracted processing codes in a manner of being executable by an electronic equipment, to transmit the processing code group for the screen processing to the electronic equipment, to execute the processing codes excluding the processing code group for the screen processing in the program upon accepting processing requests from the one or more extracted processing codes contained in the processing code group for the screen processing executed by the electronic equipment, and to transmit execution results of the processing code, associated with the processing requests, in the program to the electronic equipment.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF THE DRAWINGS

FIG. 1 is an explanatory diagram of an information processing system according to Embodiment 1.

FIG. 2A is a diagram illustrating an example of how an information processing terminal utilizes services in cooperation with wearable equipments.

FIG. 2B is an explanatory diagram a usage mode of the information processing terminal based on a screen transfer method in a comparative example.

FIG. 3A is an explanatory diagram illustrating a separating process of separating an application program into a UI processing module and a data processing module.

FIG. 3B is an explanatory diagram illustrating the separating process of separating the application program into the UI processing module and the data processing module.

FIG. 4A is a diagram illustrating an example of a hardware configuration of an information processing terminal (terminal device).

FIG. 4B is a diagram illustrating an example of a hardware configuration of a server.

FIG. 5 is an explanatory diagram of processing blocks of the information processing system according to Embodiment 1.

FIG. 6A is a flowchart illustrating processes pertaining to distributed execution of the application program by a server according to Embodiment 1.

FIG. 6B is a flowchart illustrating processes pertaining to the distributed execution of the application program by the information processing terminal according to Embodiment 1.

FIG. 7A is an explanatory diagram illustrating processes of an object manager according to Embodiment 2.

FIG. 7B is a diagram illustrating an example of a table generated by the object manager according to Embodiment 1.

FIG. 7C is a diagram illustrating an example of a table that stores determination conditions for determining migration of a function element between the separated UI processing module and the separated data processing module.

FIG. 8 is an explanatory diagram illustrating processing blocks of the information processing system according to Embodiment 2.

FIG. 9A is a flowchart illustrating a migration process on the side of the server according to Embodiment 2, in which the function element migrates between the separated UI processing module and the separated data processing module.

FIG. 9B is a flowchart illustrating a migration process on the side of the information processing terminal according to Embodiment 2, in which the function element migrates between the separated UI processing module and the separated data processing module.

FIG. 10 is an explanatory diagram illustrating processing blocks of the information processing system according to Embodiment 3.

FIG. 11A is a diagram illustrating an example of changing a threshold value for determining the migration.

FIG. 11B is a diagram illustrating an example of changing the threshold value for determining the migration.

FIG. 12A is a flowchart illustrating a process of changing the threshold value for determining the migration on the side of the server according to Embodiment 3.

FIG. 12B is a flowchart illustrating a process of changing the threshold value for determining the migration on the side of the information processing terminal according to Embodiment 3.

FIG. 13A is a diagram illustrating an example of definitions of security levels according to Embodiment 4.

FIG. 13B is a diagram illustrating an example of changing the threshold value for determining the migration according to the security levels.

FIG. 14 is an explanatory diagram illustrating processing blocks of the information processing system according to Embodiment 4.

FIG. 15A is a flowchart illustrating a process of changing the threshold value for determining the migration on the side of the server according to Embodiment 4.

FIG. 15B is a flowchart illustrating a process of changing the threshold value for determining the migration on the side of the information processing terminal according to Embodiment 4.

### DESCRIPTION OF EMBODIMENTS

The information processing terminal tends to use highly confidential information instanced by individual information and customer data. The highly confidential information used on the information processing terminal is therefore requested to ensure security against a loss of the information processing terminal, a leakage of information and other equivalent anxieties.

A usage mode based on, e.g., a screen transfer method is assumed for ensuring the security of the information pertaining to utilizing the services. According to the usage mode based on the screen transfer method, e.g., the information processing terminal transmits an accepted operation input to a cloud server and other equivalent servers connected via a communication network and other equivalent networks. The cloud server accepts the operation input transmitted from the information processing terminal, and executes a variety of mobile applications pertaining to utilizing the services. An execution result of the mobile application is transferred in the form of an application display screen to the information processing terminal.

According to the usage mode based on the screen transfer method, an entity of executing processes lies in the server side, and hence it may be sufficient that the information processing terminal displays the application display screen transferred as the processing result of the mobile application. It does not therefore happen that the information processing terminal retains the highly confidential information pertaining to the execution of the mobile application. It is feasible to enhance the security of the information pertaining to utilizing the services on the side of the information processing terminal used for the services under the mobile environment.

However, the information processing terminal in recent years comes to have an increased number of cases of using the information having a substantially large data size like, e.g., sensor data and image data for data processing. Substantial deterioration of operating responsiveness of information processing is induced in the information processing terminal to which a large quantity of data instanced by the sensor data, the image data and the application display screen data are transferred via the communication network.

Further, such a case arises that the communication network under the mobile environment involves a constraint on a communication band and a restraint by a data delay. Under the mobile environment involving the constraint on the communication band and other equivalent restrictions, it follows that the large quantity data cause further deterioration of the operating responsiveness pertaining to the information processing of the information processing terminal.

The information processing terminal used for the services under the mobile environment aims at being compatible with both ensuring security of information on the mobile applications and ensuring the operating responsiveness of the information processing terminal.

An information processing system according to one embodiment will hereinafter be described with reference to the drawings. Configurations of the following embodiments are exemplifications, and information processing terminals (electronic equipments) and servers (information processing apparatuses) each included in the information processing system are not limited to the configurations of the embodiments

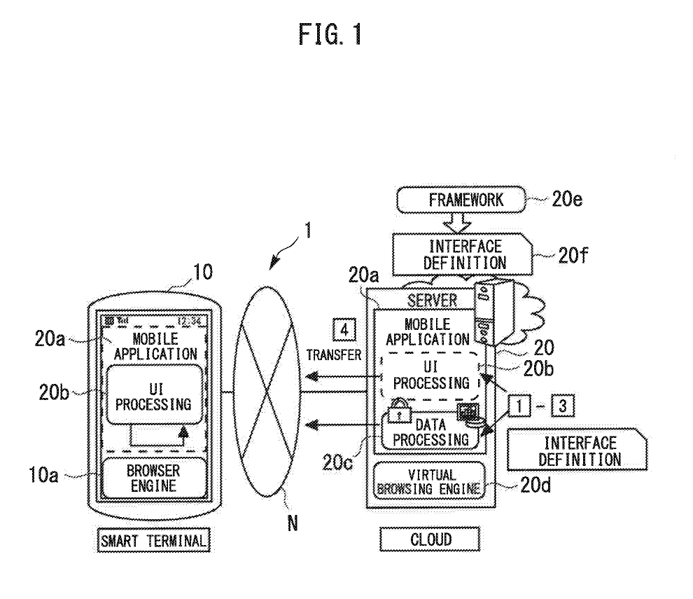

The information processing terminal and the server included in the information processing system will hereinafter be described based on the drawings of FIGS. 1 through 15.

### Embodiment 1

FIG. 1 illustrates an explanatory diagram of an information processing system 1 according to a first embodiment (Embodiment 1). The information processing system 1 illustrated in FIG. 1 includes information processing terminals (which will hereinafter be also termed electronic equipments) 10 connected to a network N, and cloud servers 20 (which will hereinafter be also termed information processing apparatuses). The network N encompasses, e.g., a public network instanced by Internet, a wireless network instanced by a mobile phone network, and LAN (Local Area Network). The network N can receive connections of a plurality of information processing terminals 10, a plurality of servers 20, and other equivalent apparatuses. The plurality of servers 20 can function as, e.g., a cloud on the network N.

In the information processing system 1 illustrated in FIG. 1, the server 20 is exemplified by a server having communication function for establishing the connection to the network N, and an information processing apparatus instanced by a PC (Personal Computer). The server 20 has, e.g., a virtual browsing engine 20d to emulate a browser engine 10a installed in the information processing terminal 10.

The information processing terminal 10 is an electronic equipment usable under, e.g., a mobile environment. The information processing terminal 10 has, e.g., the communication function for connecting with the network N. The information processing terminal 10 is installed with the browser engine 10a for connecting with the network N. The information processing terminal 10 encompasses, e.g., a smartphone, a notebook PC, a tablet PC, a PDA and other equivalent devices.

The information processing terminal 10 can be installed with mobile application programs (which will hereinafter be simply referred to as “mobile applications”) 20a usable for services under the mobile environment. The mobile application 20a is a program using OS preinstalled in, e.g., the information processing terminal 10. Execution of the mobile applications 20a enables the information processing terminal 10 to utilize services provided in cooperation with wearable devices instanced by a smartglass usable by being fitted to a head in a manner of wearing eyeglasses, and a smartwatch (wristband) equipment/sensor.

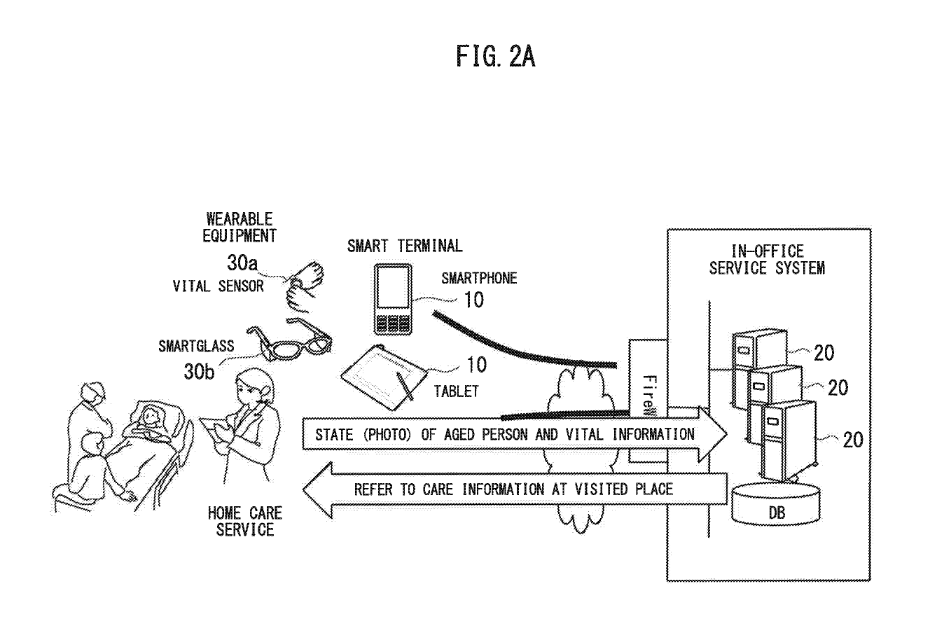

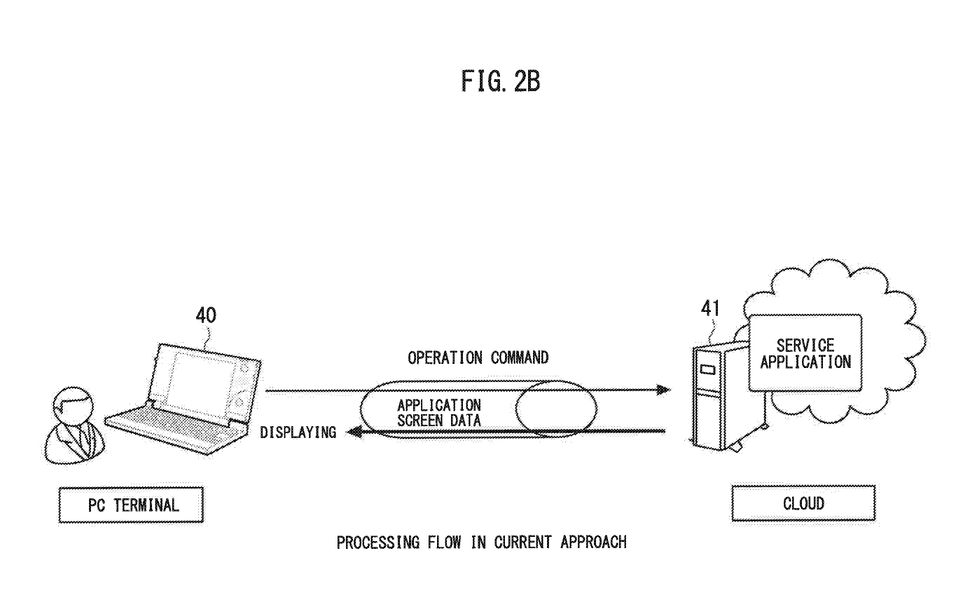

FIG. 2A illustrates one example of how the information processing terminal 10 utilizes the services in cooperation with the wearable equipments. In FIG. 2A, a person using (which will hereinafter be simply termed a “user”) the information processing terminal 10 is a person in charge of, e.g., a home care service. The user visits a care recipient's home or other equivalent places, while carrying the information processing terminal 10 instanced by the smartphone and the tablet PC. A wearable equipment, i.e., a wristband vital sensor 30a is attached to an arm or other equivalent parts of the care recipient. The vital sensor 30a attached to the care recipient measures items of vital information instanced by a pulse rate, a blood pressure and a body temperature at a predetermined time interval, e.g., one hour. The measured items of vital information are accumulated on a memory and other equivalent devices included in the vital sensor 30a and other equivalent devices in every predetermined period, e.g., every week.

The information processing terminal 10 accepts, e.g., a user's operation and executes the mobile application 20a installed in the information processing terminal 10. The information processing terminal 10 with the mobile application 20a being executed reads the items of vital information recorded and accumulated on the vital sensor 30a attached to the care recipient. The vital information is read through a near field wireless communication such as Bluetooth (registered trademark), a USB (Universal Serial Bus) and other equivalent technologies. The information processing terminal 10 further accepts the user's operation and captures real-time images of the care recipient by a camera and other equivalent devices.

The information processing terminal 10 transmits history data of the items of vital information accumulated for a predetermined period delimited by completion of reading, to the server 20 of a services system built up within an enterprise that provides the home care service. Similarly, the information processing terminal 10 transmits information of the images, captured by the camera and other equivalent devices, of the care recipient to the server 20. The history data of the items of vital information recorded and accumulated on the vital sensor 30a, are transmitted together with, e.g., the image information of the care recipient to the server 20 through executing the mobile application 20a. Various items of information transmitted from the information processing terminal 10 are received by the server 20 of the services system and accumulated in a database (DB) equipped in the server 20.

The information processing terminal 10 connects with the server 20, based on, e.g., the user's operation, and refers to items of care information accumulated in the DB equipped in the server 20. The care information contains a history of drugs taken by the care recipient, a past history of vital information, a pathogenic history of a cold or influenza and fever of the care recipient. The care information of the care recipient is displayed on a display device instanced by an LCD (Liquid Crystal Display) equipped in the information processing terminal 10 through executing, e.g., the mobile application 20a.

The information processing terminal 10 displays the care information of the care recipient within a smartglass 30b or other equivalent wearable equipments attached to the user's head and other equivalent regions. The information processing terminal 10 executing the mobile application 20a transmits, e.g., the care information, which is now referred to, to the smartglass 30b via the Bluetooth, the USB and other equivalent technologies. Screen information indicating a transition of the vital information for the predetermined period is displayed within the smartglass 30b. The user of the information processing terminal 10 refers to the screen information indicating the transition of the care information displayed on the display device instanced by the LCD, or within the smartglass 30b and other equivalent wearable equipments, and is thereby enabled to provide a proper service to the care recipient.

As described in FIG. 2A, the information utilized for the services under the mobile environment involves using highly confidential information, i.e., individual information instanced by the care information, and customer data. The information utilized for the services under the mobile environment is requested to ensure security against a loss of the information processing terminal 10, and a leakage of the information.

FIG. 2B illustrates, as a comparative example, an explanatory diagram of a usage mode of the information processing terminal based on a screen transfer method. The usage mode of the information processing terminal based on the screen transfer method illustrated in FIG. 2B is also referred to as a “thin client system”. An information processing terminal 40 and a server 41 depicted in FIG. 2B are interconnected via the network to configure the thin client system. The server 41 functions as part of the cloud on the network.

The information processing terminal 40 is, e.g., the notebook PC in the explanatory diagram illustrated in FIG. 2B. The server 41 is an information processing apparatus instanced by the PC. The server 41 is installed with the services applications for utilizing the services. It is assumed that application screen data, transferred from the server 41 on the cloud, of the services application in execution are to be already displayed on the display device, instanced by the LCD, of the information processing terminal 40.

The information processing terminal 40 accepts an input of the user's operation inputted while referring to the application screen data displayed on the display device. The user's operation is inputted via, e.g., a keyboard of the information processing terminal 40. The information processing terminal 40 transmits the accepted input of the user's operation as, e.g., an operation command to the server 41.

The server 41 receives the operation command transmitted from the information processing terminal 40 via the network, and reflects a process associated with the received operation command in the services application in execution. The process associated with the received operation command is reflected therein, as a result of which processes of the services application in execution are updated. As a result of updating the processes of the services application in execution, the server 41 generates post-updating application screen data associated with the services application. The application screen data are screen data described in, e.g., HTML (HyperText Markup Language) and other equivalent languages.

The server 41 transfers the generated application screen data to the information processing terminal 40. The information processing terminal 40 receives the application screen data transferred from the server 41 via the network. The information processing terminal 40 performs a display process based on the received application screen data, thereby displaying the application screen data on the display device instanced by the LCD. The post-updating application screen data based on the services application in which the input of the user's operation is reflected, are displayed on a display screen of the information processing terminal 40.

As described above, according to the usage mode based on the screen transfer method, the server 41 executes the processes of the services application. The information processing terminal 40 receives the application screen data transferred as a processing result of the services application, and executes the display process. The information processing terminal 40 does not include the services application becoming an entity of subject of the execution, and does not therefore retain the highly confidential information related to executing the services application. The usage mode based on the screen transfer method enables enhancement of the security against the loss of the information processing terminal, the leakage of the information and other equivalent anxieties.

As described in FIG. 2A, however, the information processing terminal 10 transmits, to the server 20, a large quantity of data like the image data and the sensor data related to executing the mobile application 20a as the case may be. The server 20 likewise transmits, to the information processing terminal 10, the processing result of the mobile application 20a based on the image data and the sensor data by way of the application screen data as the case may be.

The large quantity of data are transmitted and received between the information processing terminal 10 and the server 20, in which case it follows that the information processing terminal 10 adopting the screen transfer method is pressed in terms of a processing performance when performing a data transmitting/receiving process. Therefore, the information processing terminal 10 adopting the screen transfer method has a possibility that an operating responsiveness in the information processing terminal 10 is substantially deteriorated. The information processing terminal 10 used for the services under the mobile environment requested to respond quickly, is hard to provide a proper process due to the deteriorated operating responsiveness in some cases.

Referring back to the explanatory diagram illustrated in FIG. 1, the cloud server 20 of the information processing system 1 according to Embodiment 1 is installed with the mobile application 20a executable by the information processing terminal 10. The mobile application 20a is a program used for the services under the mobile environment. The mobile application 20a is programmed by using, e.g., a framework 20e based on the OS preinstalled in the information processing terminal 10.

The framework 20e is a framework configured by a software developer to facilitate use of API (Application Programming Interface) employed for the processes of the mobile application 20a, corresponding to the OS preinstalled in the information processing terminal 10. The use of the framework 20e leads to, e.g., providing batchwise generalized program functions used for programming the mobile application 20a and for other equivalent purposes. The framework 20e encompasses, e.g., subroutines contained in the API, design models for enhancing versatility by using data structures, object classes, variables and other equivalent components, and processing patterns. The framework 20e may be exemplified by “AngularJS”, “Vue.js”, “batman.js”, “Backbone.js” and “Knockout”.

The program of the mobile application 20a may be made as source codes separately into, e.g., a processing module matching with UI processing and a processing module matching with data processing by using the framework 20e.

Herein, the processing module matching with the UI processing is a program module declared in a define statement for defining, e.g., a screen displayed on the information processing terminal 10. The processing module matching with the data processing is a program module exclusive of, e.g., the processing module matching with the UI processing. The processing module matching with the data processing is, e.g., a program module executed in the background of the information processing terminal 10 displaying the screen in progress. Note that the processing module matching with the UI processing is referred to as the “UI processing”, while the processing module matching with the data processing is also referred to as the “data processing” in the following discussion.

The server 20 according to Embodiment 1 includes, e.g., an interface definition 20f for the mobile application 20a. The interface definition 20f is generated based on the framework 20e used for programming, e.g., the mobile application 20a. The server 20 contains the interface definition 20f per, e.g., mobile application 20a to be installed.

The interface definition 20f contains, e.g., a name for identifying the framework 20e used for programming the mobile application 20a. The interface definition 20f contains, e.g., a declaration statement for defining the UI processing on a source program (which will be also termed “source codes”) of the mobile application 20a. The declaration statement for defining the UI processing contains define statements for generating objects of the UI processing. Similarly, the interface definition 20f contains a declaration statement for defining the data processing on the source codes of the mobile application 20a. The declaration statement for defining the data processing contains definition statements for generating the objects of the data processing. Note that the “objects” contain, e.g. arrays, data like image data, functions, variables or combinations thereof.

The server 20 according to Embodiment 1 refers to, e.g., the interface definition 20f, and analyzes the source codes of the installed mobile application 20a. The server 20 separates the source codes of the installed mobile application 20a into UI processing 20b and data processing 20c. In the information processing terminal 10, the server 20 separates the mobile application 20a executable as a stand-alone program into the UI processing 20b defined as a program group for generating the objects to define the screen, and the data processing 20c of the program group exclusive of the UI processing 20b.

In the information processing system 1 according to Embodiment 1, the UI processing 20b of the mobile application 20a separated by the server 20 is transferred to the information processing terminal 10 and is executed by using resources of the information processing terminal 10. On the other hand, the data processing 20c of the mobile application 20a separated by the server 20 is retained in the server 20 and is executed by using resources of the server 20.

Note that the UI processing 20b of the mobile application 20a transferred to the information processing terminal 10 is provided with, e.g., an interface proxy (which will hereinafter be simply referred to as the “IF proxy”) for transferring and receiving the data to and from the server 20. Similarly, the data processing 20c of the mobile application 20a retained by the server 20 is also provided with an IF proxy for transferring and receiving the data to and from the UI processing 20b of the information processing terminal 10. The IF proxies provided to the UI processing 20b and the data processing 20c are provided, e.g., per mobile application 20a.

The UI processing 20b executed by the information processing terminal 10 transfers and receives the data to and from the data processing 20c executed by, e.g., the server 20 via the IF proxy, and is thereby enabled to function as the mobile application 20a. The information processing system. 1 according to Embodiment 1 distributes the mobile applications 20a used for the services under the mobile environment to the information processing terminal 10 and the cloud server 20, and can thus execute the mobile applications 20a.

The information processing system 1 according to Embodiment 1 can execute the mobile application 20a by distributing the data processing 20c of the mobile application 20a to the server 20, and hence it does not happen that, for example, the information processing terminal 10 retains the highly confidential information instanced by the individual information pertaining to utilizing the services. The information processing terminal 10 can execute the mobile application 20a by distributing the data processing 20c of the mobile application 20a to the server 20, and it therefore follows that processing loads on the resources pertaining to the data processing can be reduced. The information processing terminal 10 can perform the UI processing 20b pertaining to the display on the screen of the mobile application 20a by using the self-resources of the information processing terminal 10 without conducting communications with the server 20, thereby enabling enhancement of the responsiveness with respect to, e.g., the operation input, the display output and other equivalent events on the display screen.

The information processing system 1 according to Embodiment 1 can reduce a data traffic between the cloud server 20 and the information processing terminal 10 down to a data transmitting/receiving quantity between the distributed modules, i.e., the data processing 20c and the UI processing 20b. A traffic load between the server 20 and the information processing terminal 10 can be reduced as compared with the mode of the screen transfer method illustrated in FIG. 2B. The information processing system 1 according to Embodiment 1 enables improvement of the operating responsiveness pertaining to a user interface process as compared with the mode of the screen transfer method illustrated in FIG. 2B. For example, even in such an instance that the communication network under the mobile environment involves restrictions on a communication band, a data delay and other equivalent elements, it is feasible to reduce deterioration of the operating responsiveness of the information processing terminal 10. The information processing system 1 according to Embodiment 1 is compatible with both ensuring the security of the information pertaining to utilizing the services of the information processing terminal 10 and ensuring the operating responsiveness.

(Separating Process of Mobile Application)

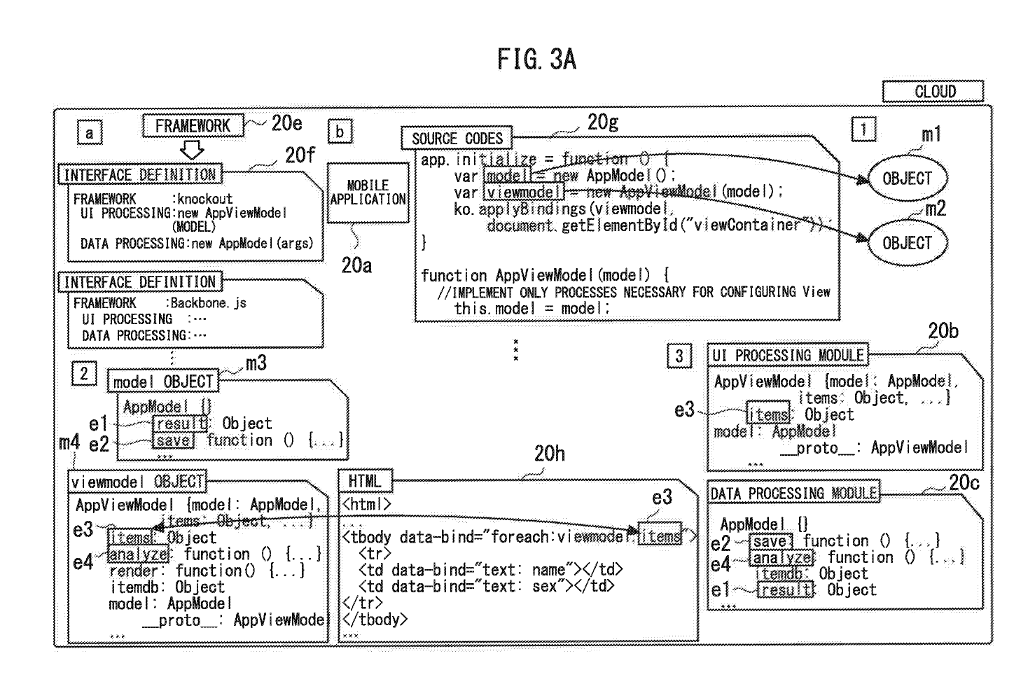

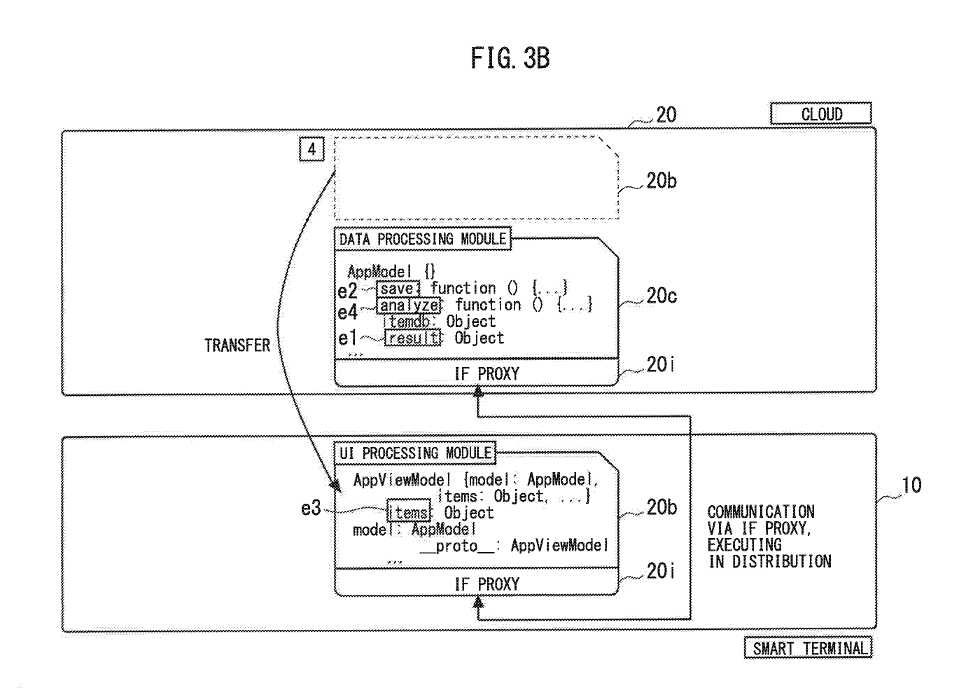

A separating process of separating the mobile application 20a executed by the server 20 of the information processing system 1 according to Embodiment 1 into the UI processing 20b and the data processing 20c, will hereinafter be described with reference to drawings illustrated in FIGS. 3A and 3B.

FIG. 3A is an explanatory diagram of the separating process of separating the mobile application 20a into the UI processing 20b and the data processing 20c. FIG. 3B is an explanatory diagram of a transfer process after completion of the separating process. Note that the mobile application 20a in the explanatory examples of FIGS. 3A and 3B is one example in which “Knockout” defined as a library of JavaScript (registered trademark) is programmed by using the framework 20e.

In the explanatory diagram of FIG. 3A, as depicted in a portion a, the server 20 of the information processing system 1 according to Embodiment 1 includes the interface definition 20f with respect to the mobile application 20a. The interface definition 20f has already been described in FIG. 1. The interface definition 20f is equipped per mobile application 20a. Note that the interface definition 20f equipped in the server 20 is provided by, e.g., a software developer of the framework 20e or by a service provider for providing the services via the mobile application 20a.

As illustrated in FIG. 3A, the interface definition 20f contains a name for identifying the framework 20e used for programming the mobile application 20a. Similarly, the interface definition 20f contains the define statements (declaration statement) for generating the objects to define the UI processing and the define statements for generating the objects to define the data processing on the source codes of the mobile application 20a. The explanatory diagram in FIG. 3A illustrates the interface definition 20f of the mobile application 20a programmed based on “Knockout” or “Backbone.js” as the framework 20e.

In the explanatory example of FIG. 3A, e.g., the interface definition 20f of the mobile application 20a developed based on “Knockout” as the framework 20e, has a “framework” column, a “UI processing” column and a “data processing” column. For example, the name “Knockout” for identifying the framework 20e is registered in the “framework” column. For instance, a define statement “new AppViewModel (MODEL)” to generate the object for defining the UI processing on the source codes is registered in the “UI processing” column. For example, a define statement “new AppModel (args)” to generate the object for defining the data processing on the source codes is registered in the “data processing” column. The define statement “new AppViewModel (MODEL)” registered in the “UI processing” column and the define statement “new AppModel (args)” registered in the “data processing” column, are generated along programming rules of, e.g., the framework “Knockout”.

A portion b in FIG. 3A illustrate source codes 20g of the mobile application 20a. The source codes 20g of the mobile application 20a are described by using a programming language instanced by “JavaScript”. The server 20 analyzes the source codes 20g of the mobile application 20a by referring to, e.g., the interface definition 20f. As a result of the analysis, the server 20 specifies the define statements to generate the objects for defining the UI processing and the data processing on the source codes 20g of the mobile application 20a.

The server 20 acquires the define statement “new AppViewModel (MODEL)” to generate the object for defining the UI processing by referring to, e.g., the interface definition 20f of the mobile application 20a. The server 20 searches the source codes 20g of the mobile application 20a by using, e.g., a character string “new AppViewModel( )” of the acquired define statement.

In the source codes 20g, for example, the character string “new AppViewModel( )” of the define statement is contained in a description of “var viewmodel=new AppViewModel( );”. A code element “viewmodel” contained in a character string described in a position previous to “new AppViewModel( )” describes a high-order object m2 to generate the object for defining the UI processing. Note that a relative positional relationship on the source codes 20g between the character string “new AppViewModel( )” of the define statement and “var viewmodel=” described in the position previous to “new AppViewModel( )” of the define statement, is associated based on the rules specified by, e.g., the framework 20e.

The server 20 specifies a character string, i.e., “var viewmodel” associated with “new AppViewModel( )” on the source codes 20g. The code element “var viewmodel” declares that the character string “viewmodel” is a variable on the source codes. The character string “new AppViewModel( )” of the define statement is a function to generate an object for executing the UI processing. It therefore follows that “var viewmodel=new AppViewModel( );” indicates substituting the object for the UI processing, which is generated by the function AppViewModel(model)”, into the variable “viewmodel”.

As illustrated in 1 of FIG. 3A, the server 20 acquires “viewmodel” contained in the specified character string as the high-order object m2 to generate the object for defining the UI processing.

Similarly, the server acquires a define statement “new AppModel(args)” to generate an object for defining the data processing by referring to, e.g., the interface definition 20f of the mobile application 20a. The server 20 searches the source codes 20g of the mobile application 20a by using, e.g., a character string “new AppModel( )” of the acquired define statement.

In the source codes 20g, for instance, the character string “new AppModel( )” of the define statement is contained in a description of “var model=new AppModel( );”. A code element “model” contained in the character string “var model” described in a position previous to “new AppModel( )” describes a high-order object m1 to generate an object for defining the data processing. Herein, a relative positional relationship on the source codes 20g between the character string “new AppModel( )” of the define statement and “var model” describe in the position previous to “new AppModel( )” of the define statement, is associated based on the rules specified by, e.g., the framework 20e.

The server 20 specifies a character string, i.e., “var model” associated with, e.g., “new AppModel( )”. The server 20 acquires “model” contained in the specified character string as a variable name representing the high-order object m1 to generate the object for defining the data processing.

The high-order objects m1, m2 contain low-order objects instanced by the functions and the variables. The server 20 specifies the elements, i.e., the functions and the variables contained in the high-order objects m1, m2 from within the acquired high-order objects m1, m2.

The elements, i.e., the functions and the variables contained in the high-order objects m1, m2 use arbitrary names assigned by, e.g., the software developer (programmer) of the mobile application 20a. The server 20 classifies, e.g., the high-order object m1 as “model object”. The server 20 likewise classifies, e.g., the high-order object m2 as “viewmodel object”.

In 2 of FIG. 3A, a table m3 illustrates one example of “model object” classified from the high-order object m1 specified based on the interface definition 20f. Similarly, a table m4 illustrates one example of “viewmodel object” classified from the high-order object m2 specified based on the interface definition 20f.

The table m3 has an enumeration of low-order elements e1, e2 contained in the high-order object m1 to define an entity of the object in the source codes 20g retained on a main storage device of the server 20. In the table m3, “result” is a variable name representing the low-order element e1 contained in, e.g., the high-order object m1. The variable name “result” indicates a processing result of an arithmetic process executed within, e.g., the high-order object m1. Similarly, “save” is a function name representing an element e2 contained in, e.g., the high-order object m1. The data and other equivalent items acquired in, e.g., the high-order object m1 are recorded by “save”.

The table m4 has an enumeration of elements e3, e4 contained in the high-order object m2 to define an entity of the object in the source codes 20g retained on the main storage device of the server 20. In the table m4, “items” is a variable name representing the element e3 contained in the high-order object m2. Similarly, “analyze” is a function name representing the element e4 contained in, e.g., the high-order object m2. The “items” indicates a display component and other equivalent components processed to be displayed on the display screen and other equivalent units of the information processing terminal 10 by executing the high-order object m2. The execution of the high-order object m2 causes “analyze” to extract data in a specified position from within a plurality of data arrays. Note that the table m4 includes other variable names instanced by “itemdb” and other function names instanced by “render”.

Note that the screen displayed on the display device exemplified by the LCD is described by using a Markup Language like HTML (HyperText Markup Language) according to the program instanced by the mobile application 20a installable into the information processing terminal 10. The mobile application 20a therefore contains an HTML file 20h described by using the Markup Language as illustrated in 2 surrounded in a rectangular shape in FIG. 3A in addition to the source codes 20g described by using the programming language like “JavaScript (registered trademark)”. The screen of the mobile application 20a may, however, be described by using other Markup Languages instanced by XML (Extensible Markup Language) and XAML (Extensible Application Markup Language). The following discussion will be made on the assumption that the screen displayed on the display device instanced by the LCD of the information processing terminal 10 is described by HTML.

The server 20 checks, e.g., the variable names (e1, e3) and the function names (e2, e4) of the tables m3, m4 against the HTML file 20h. The server 20 associates the variables and the functions contained in, e.g., “viewmodel object” with the HTML file 20h, and further associates the variables and the functions contained in “model object” with the HTML file 20h.

For instance, the define statements for the UI processing, which are registered in the interface definition 20f, contain function names and variable names not used as elements for describing the display screen. For example, such a case may arise that the functions, the variables and other equivalent elements programmed during the development of the mobile application 20a are changed, postponed or deleted in usage schedule. In this case, e.g., it can be assumed to delete the relevant variable name and function name from the description (HTML and other equivalent languages) of the display screen in an as-is status of not applying modifications instanced by the deletion with respect to the source codes 20g. There exists also a case that the elements like the functions and the variables inherently contained in the define statement for the data processing are erroneously inserted into the define statement for the UI processing as the case may be.

The server 20 checks the variable names (e1, e3) and the function names (e2, e4) of the tables m3, m4 against the HTML file 20h, and is thereby enabled to improve, e.g., accuracy of separating the mobile application 20a into the UI processing and the data processing. Note that the elements of the tables m3, m4 are checked against contents described in the HTML file 20h by detecting, e.g., coincidences of the character strings contained in the names assigned to the elements.

The server 20 checks, e.g., the variable names (e1, e3) and the function names (e2, e4) of the tables m3, m4 against the HTML file 20h, thereby extracting the elements, i.e., the functions, the variables and other equivalent elements described in the HTML file 20h.

For example, the HTML file 20h in FIG. 3A contains the variable name “items” of the element e3 of the table m4 as “viewmodel object”. The server 20 searches the HTML file 20h by using, e.g., the variable name “items” of the element e3 as a character string for checking. As a result of the search, the variable name “items” described in the HTML file 20h is specified as the character string coincident with the character string for checking. The server 20 extracts, e.g., the element e3 of the table m4, i.e., the “viewmodel object” as an element name described in the HTML file 20h.

The HTML file 20h is also assumed not to contain the variable name “analyze” of the element e4 classified as “viewmodel object” in the table m4. In this case, the variable name “analyze”, as the character string for checking, of the element e4 is not retrieved from the HTML file 20h. The server 20 therefore extracts, e.g., the element e4 classified to be the “viewmodel object” as an element name not described in the HTML file 20h.

The server 20 checks, e.g., the respective elements classified as “model object” against the checking target descriptions of the HTML file 20h in the same way with “viewmodel object”. As a result of checking, when the HTML file 20h has a coincident description, the coincident element is extracted as the element name described in the HTML file 20h. Whereas when the HTML file 20h has none of the coincident description, the checking target element is extracted as the element name not described in the HTML file 20h.

The elements (e1, e2) in the table m3 illustrated in FIG. 3A are respectively extracted, e.g., as the element names not described in the HTML file 20h. Similarly, the elements (e3, e4) in the table m4 are extracted, e.g., as the element names described in the HTML file 20h. Further, the element e4 is extracted as the element name not described in the HTML file 20h.

As a result of checking, the server 20 integrates the elements in the tables m3, m4, which are extracted as the element names described in the HTML file 20h, and modularizes the integrated elements into a UI processing module 20b. Similarly, the server 20 integrates the elements in the tables m3, m4, which are extracted as the element names not described in the HTML file 20h, and modularizes the integrated elements into a data processing module 20c.

The UI processing module 20b and the data processing module 20c are generated as a result of the modularization. The thus-generated UI processing module 20b is equivalent to the UI processing 20b illustrated in, e.g., FIG. 1. The thus-generated data processing module 20c is equivalent to the data processing 20c illustrated in, e.g., FIG. 1. The mobile application 20a installable into the information processing terminal 10 is separated into the UI processing module 20b and the data processing module 20c through an analyzing process using the interface definition 20f.

The UI processing module 20b illustrated in FIG. 3A contains, e.g., the variable name “items” of the element e3, which is extracted as the element name described in the HTML file 20h. Similarly, the data processing module 20c illustrated in FIG. 3A contains, e.g., the variable names “result”, “save”, “analyze” of the elements e1, e2, e4 extracted as the element names not described in the HTML file 20h.

Herein, the data processing module 20c contains the element e4 described as “viewmodel object” in the table m4. It is recognized that the data processing module 20c contains the function element “analyze” building up the high-order object m2 to generate the object for defining the UI processing. It is also recognized that the function element “analyze” associated with the define statement “new AppViewModel (MODEL)”, registered in the interface definition 20f, for the UI processing on the source codes 20g of the mobile application 20a, is the function element on the side of the data processing.

Note that the discussion has been made to describe the separation of the source codes 20g of the mobile application 20a into the UI processing module 20b and the data processing module 20c, based on the HTML file 20h. For example, the items of data themselves stored in the memory and other equivalent storages may be extracted and separated as the data processing module 20c from the source codes 20g of the mobile application 20a. In this case, e.g., other elements exclusive of the data stored in the memory and other equivalent storages are separated as the UI processing module 20b. The items of data themselves stored in the memory and other equivalent storages are extracted and separated as the data processing module 20c, thereby enabling absorption of, e.g., a difference between the frameworks.

For instance, “save” of the element e3 classified in the table m3 is defined as a function for storing the data. For example, the variable names to be defined within “save” of the element e3 are extracted and combined, thereby enabling the combined variable names to be classified in the data processing module 20c.

Next, a transfer process of the UI processing module 20b separated from the mobile application 20a will be described with reference to FIG. 3B. As described in FIG. 1, the UI processing module 20b separated from the mobile application 20a is transferred to the information processing terminal 10. The UI processing module 20b is provided with an IF proxy 20i and is transferred to the information processing terminal 10 from the server 20. Note that the data processing module 20c separated from the mobile application 20a is provided with the IF proxy 20i and is retained in the server 20.

The IF proxy 20i is a program for transferring and receiving the data between the UI processing module 20b transferred to the information processing terminal 10 and the data processing module 20c retained in the server 20.

The IF proxy 20i performs bidirectional communications between the UI processing module 20b and the data processing module 20c distributed to the information processing terminal 10 and the server 20, based on Communication Standards instanced by “WebSocket”.

The IF proxy 20i enables the information processing terminal 10 executing the UI processing module 20b and the server 20 executing the data processing module 20c to function as equipments in a server/client system. Note that the IF proxy 20i is provided, e.g., per mobile application 20a.

The UI processing module 20b transferred to the information processing terminal 10 is retained together with, e.g., the IF proxy 20i in the information processing terminal 10. The UI processing module 20b transferred to the information processing terminal 10 is executed by use of, e.g., the resources of the information processing terminal 10. The execution of the UI processing module 20b causes the screen described by, e.g., the HTML file 20h to be displayed on the display device instanced by the LCD of the information processing terminal 10.

In the information processing terminal 10, e.g., the execution of the UI processing module 20b of the mobile application 20a causes occurrence of a data processing request in an execution process of the elements (the function, the variable and other equivalent elements) for defining the screen described by the HTML file 20h. The UI processing module 20b to be executed by the information processing terminal 10 hands over an argument (parameter) of the process with the occurrence of the data processing request to the IF proxy 20i of the information processing terminal 10. The IF proxy 20i of the information processing terminal 10 transmits the argument of the process with the occurrence of the processing request to the cloud server 20 executing the data processing module 20c via, e.g., the network N.

The server 20 receives the argument, transmitted from the information processing terminal 10, of the process with the occurrence of the processing request via the IF proxy 20i of the server 20. For example, the IF proxy 20i of the server 20 hands over the received argument of the process to the data processing module 20c executed by the server 20. The data processing module 20c executed by the server 20 executes the data processing, e.g., corresponding to the argument of the process. The data processing module 20c hands over, e.g., a result of executing the data processing as a return value with respect to the argument to the IF proxy 20i of the server 20. The result of executing the data processing, which is handed over as the return value to the IF proxy 20i of the server 20, is transmitted to the information processing terminal 10 via, e.g., the network N.

The result of executing the data processing, which is transmitted from the server 20, is received via the IF proxy 20i of, e.g., the information processing terminal 1. The result of executing the data processing, which is received via the IF proxy 20i, is handed over as the return value to, e.g., the process with the occurrence of the processing request of the UI processing module 20b executed in progress.

In the information processing system 1 according to Embodiment 1, the functions of the mobile application 20a are distributed to and executed by the information processing terminal 10 receiving the transferred UI processing module 20b and the server 20 retaining the data processing module 20c. The UI processing module 20b of the information processing terminal 10 and the data processing module 20c of the server 20 are executed asynchronously by using the resources of the respective equipments. However, the screen to be displayed on the display device instanced by LCD of the information processing terminal 10, i.e., the data processing result transmitted from the server 20, is displayed in synchronization with executing the UI processing module 20b.

[Configuration of Equipment]

(Information Processing Terminal)

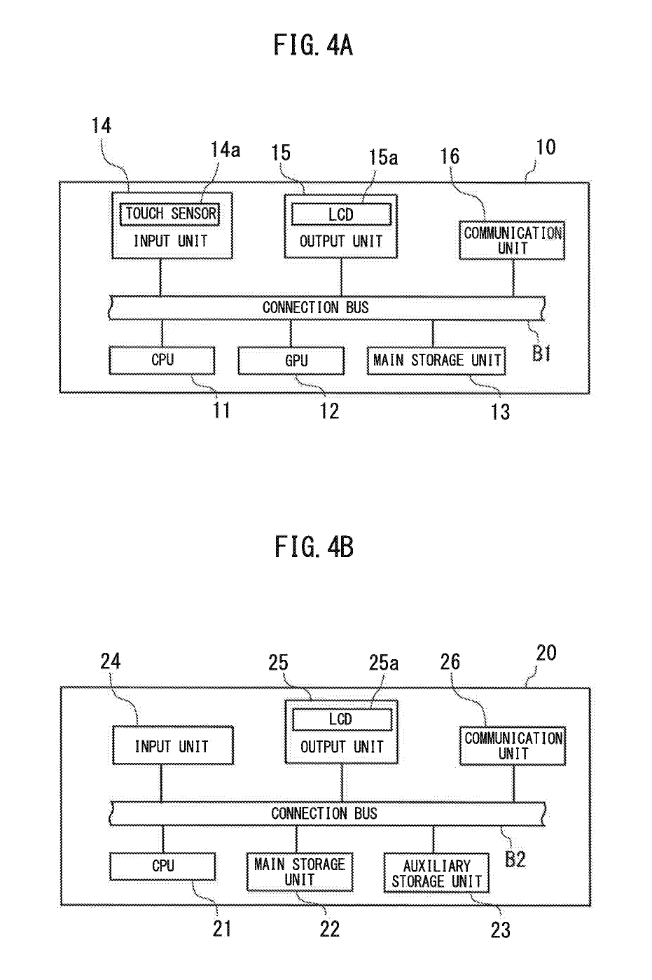

FIG. 4A illustrates a hardware configuration of the information processing terminal 10. The information processing terminal 10 illustrated in FIG. 4A includes a CPU (Central Processing Unit) 11, a GPU (Graphics Processing Unit) 12 and a main storage unit 13, which are interconnected via a connection bus B1. The information processing terminal 10 further includes an input unit 14, an output unit 15 and a communication unit 16, which are connected to the connection bus B1. The main storage unit 13 is a non-transitory recording medium readable by the information processing terminal 10. The main storage unit 13 includes, e.g., a RAM (Random Access Memory) and a ROM (Read Only Memory).

The information processing terminal 10 deploys programs stored in the ROM and other equivalent storages of the main storage unit 13 onto working areas of the RAM: and other equivalent storages in an executable manner, and controls peripheral devices through executing the programs. The information processing terminal 10 is thereby enabled to provide functions matching with predetermined purposes.

In the information processing terminal 10, the CPU 11 is a central processing unit that controls the whole information processing terminal 10. The CPU 11 carries out processes based on the programs stored, e.g., in the ROM and other equivalent storages of the main storage unit 13. The GPU 12 is a processor to execute mainly a process of displaying the screen data to be displayed in a display area of the display device. The information processing terminal 10 includes the GPU 12 and can be thereby expected to reduce a processing load on the CPU 11 pertaining to, e.g., the display process and to speed up the display process on the display device instanced by an LCD 15a.

The RAM and other equivalent storages of the main storage unit 13 are storage mediums used for the CPU 11 to cache the programs and the data and deploy the working areas. The ROM and other equivalent storages of the main storage unit 13 are nonvolatile semiconductor memories. The ROM and other equivalent storages of the main storage unit 13 store various categories of programs encompassing a communication interface program for transferring and receiving the data to and from the server 20 and other equivalent machines connected via the OS and the communication unit 16.

The OS provides, e.g., an interface with the resources under management to the applications instanced by the UI processing module 20b transferred from the server 20. The UI processing module 20b and other equivalent modules use the interface, provided by the OS, with the resources, thereby causing the application functions to work. The OS contains a communication interface program for transferring and receiving the data to and from the wearable equipments connected via the communication unit 16.

The input unit 14 accepts an operating instruction and other equivalent instructions from a user and other equivalent administrators. The input unit 14 is an input device exemplified by an input button, a pointing device, a microphone and a camera. The input unit 14 may include a keyboard, a wireless remote controller and other equivalent devices. The pointing device includes a touch panel configured by combining, e.g., a touch sensor 14a with the display device instanced by the LCD 15a of the output unit 15, a mouse, track ball, a joystick and other equivalent devices.

The output unit 15 outputs the data processed by the CPU 11 and the data stored in the main storage unit 13. The output unit 15 is an output device exemplified by a CRT (Cathode Ray Tube) display, the LCD (Liquid Crystal Display) 15a, a PDP (Plasma Display Panel), an EL (Electroluminescence) panel, an organic EL panel, a printer, a speaker and other equivalent devices.

The communication unit 16 is, e.g., an interface with the network N and other equivalent networks to which the information processing terminal 10 connects. Note that the information processing terminal 10 receives via the communication unit 16 connections of the wearable equipments instanced by the wristband vital sensor 30a, the smartglass 30b and other equivalent equipments illustrated in FIG. 2A, which are used under the mobile environment.

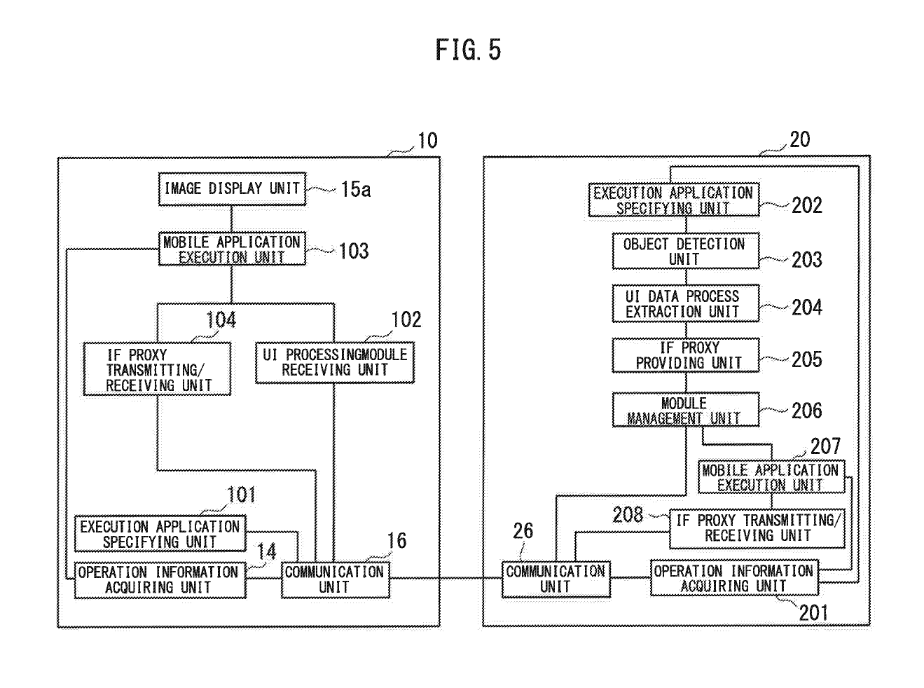

For example, the CPU 11 reads the various categories of programs and the various items of data stored in the ROM and other equivalent storages of the main storage unit 13 into the RAM and other equivalent storages, and executes the programs and the data, whereby the information processing terminal 10 provides respective processing functions illustrated in FIG. 5 along with executing the target programs.

Along with executing the target programs, the information processing terminal 10 provides an execution application specifying unit 101, a UI processing module receiving unit 102, a mobile application execution unit 103, and an IF proxy transmitting/receiving unit 104 illustrated in FIG. 5. Any one or part of these processing functions illustrated in FIG. 5 may also be configured to operate by a hardware circuit.

(Server)

FIG. 4B depicts a hardware configuration of the server 20. The server 20 depicted in FIG. 4B has a configuration of a so-called general computer. The server 20 includes a CPU (Central Processing Unit) 21, a main storage unit 22, an auxiliary storage unit 23, an input unit 24, an output unit 25 and a communication unit 26, which are interconnected via a connection bus B2. The main storage unit 22 and the auxiliary storage unit 23 are non-transitory recording mediums readable by the server 20.

The CPU 21 deploys the programs stored in the auxiliary storage unit 23 onto the working areas of the main storage unit 22 in the executable manner, and the server 20 controls the peripheral devices through executing the programs. The server 20 is thereby enabled to provide functions matching with predetermined purposes.

The CPU 21 is a central processing unit to control the whole server 20. The CPU 21 executes processes, based on the programs stored in the auxiliary storage unit 23. The main storage unit 22 is a storage medium used for the CPU 21 to cache the programs and the data and to deploy the working areas. The main storage unit 22 encompasses, e.g., the RAM (Random Access Memory) and the ROM (Read Only Memory).

The auxiliary storage unit 23 stores the various categories of programs and the various items of data in the recording mediums in a readable/writable manner. The auxiliary storage unit 23 is called also an external storage device. The auxiliary storage unit 23 stores the OS, the various categories of programs, a variety of tables and other equivalent software components. The OS provides, e.g., an interface with the resources under management to the installed applications. Use of the resource interface provided by the OS causes functions of the applications installed into the server 20 to work. The OS contains a communication interface program for transferring and receiving the data to and from the information processing terminal 10, external equipments and other equivalent equipments, which are interconnected via the communication unit 26. The external equipments include, e.g., other information processing apparatuses instanced by PCs and servers, external storage devices and other equivalent devices on the network N.

The auxiliary storage unit 23 is exemplified by an EPROM (Erasable Programmable ROM), a solid-state drive and a hard disk drive (HDD). For example, a CD drive, a DVD drive, a BD drive and other equivalent drives can be given as the auxiliary storage unit 23. The recording mediums are exemplified by a silicon disk including a nonvolatile semiconductor memory (flash memory), a hard disk, a CD, a DVD, a BD, a USB (Universal Serial Bus) memory and a memory card.

The input unit 24 accepts an operating instruction and other equivalent instructions from an operator and other equivalent administrators. The input unit 24 is an input device, i.e., the input button, the pointing device like the mouse, and the microphone. The input unit 24 may include the keyboard, the wireless remote controller and other equivalent devices. The CPU 21 is notified of information inputted from the input unit 24 via the connection bus B2.

The output unit 25 outputs the data processed by the CPU 21 and the data stored in the main storage unit 22. The output unit 25 includes an LCD 25a, the CRT (Cathode Ray Tube) display, the PDP (Plasma Display Panel), the EL (Electroluminescence) panel, the organic EL panel and other equivalent devices. The output unit 25 further includes the output device instanced by the printer and the speaker. The communication unit 26 I, e.g., an interface with the network N and other equivalent networks to which the server 20 connects.

The CPU 21 reads the OS, the various categories of programs and the various items of data stored in the auxiliary storage unit 23 into the main storage unit 22 and executes these software components, whereby the server 20 provides the respective processing functions illustrated in FIG. 5 along with executing the target programs.

Through the execution of the target programs, the server 20 provides an operation information acquiring unit 201, an execution application specifying unit 202, an object detection unit 203, a UI data process extraction unit 204, and an IF proxy providing unit 205 illustrated in FIG. 5. Similarly, the server 20 provides a module management unit 206, a mobile application execution unit 207, and an IF proxy transmitting/receiving unit 208 illustrated in FIG. 5. Note that any one of or part of the respective processing functions illustrated in FIG. 5 may be configured to operate by the hardware circuit. The server 20 includes the auxiliary storage unit 23, to which the processing functions described above refer, or serving as a storage location of the data under management.

[Configuration of Processing Blocks]

FIG. 5 illustrates an explanatory diagram of processing blocks in the information processing system according to Embodiment 1. In the explanatory diagram illustrated in FIG. 5, the information processing terminal 10 includes processing functions, i.e., an execution application specifying unit 101, a UI processing module receiving unit 102, a mobile application execution unit 103, and an IF proxy transmitting/receiving unit 104. Note that the terminal equipment 10 includes, a RAM and other equivalent storages of the main storage unit 13, to which the processing functions described above refer, or serving as a storage location of the data under management.

In the explanatory diagram depicted in FIG. 5, the server 20 includes processing functions, i.e., an operation information acquiring unit 201, an execution application specifying unit 202, an object detection unit 203, a UI data process extraction unit 204, and an IF proxy providing unit 205. The server 20 further includes processing functions, i.e., the module management unit 206, the mobile application execution unit 207, and the IF proxy transmitting/receiving unit 208. The server 20 includes, e.g., the auxiliary storage unit 23 and other equivalent storages, to which the processing functions described above refer, or serving as a storage location of the data under management.

(Server)

In the explanatory diagram depicted in FIG. 5, the operation information acquiring unit 201 of the server 20 acquires, e.g., operation input information, execution application specifying information and other equivalent information transmitted from the information processing terminal 10 via the communication unit 26. The operation input information contains an operation input and other equivalent inputs to the mobile application 20a distributed to and currently executed by the information processing terminal 10. The execution application specifying information contains, e.g., a boot request associated with the mobile application 20a.

For example, a plurality of icons and other equivalent tool buttons associated with the executable mobile applications 20a are displayed on an initial screen of the information processing terminal 10. The information processing terminal 10 accepts, e.g., the operation inputs to the icons and other equivalent tool buttons displayed on the initial screen. The information processing terminal 10 transmits identifying information of the mobile application 20a associated with, e.g., the selected icon, and the boot request for the application as the execution application specifying information to the server 20.

The operation information acquiring unit 201 temporarily stores, e.g., the operation input information, the execution application specifying information and other equivalent information of the information processing terminal 10, which are acquired via the communication unit 26, in predetermined areas of the main storage unit 22. The operation information acquiring unit 201 hands over, e.g., the acquired operation input information of the information processing terminal 10 to the mobile application execution unit 207. The operation information acquiring unit 201 further hands over, e.g., the acquired execution application specifying information of the information processing terminal 10 to the execution application specifying unit 202.

The execution application specifying unit 202 specifies the mobile application 20a with occurrence of the boot request, based on, e.g., the execution application specifying information handed over from the operation information acquiring unit 201. The execution application specifying unit 202 further specifies the interface definition 20f associated with the specified mobile application 20a. As described in FIG. 3A, the interface definition 20f is generated based on the framework 20e used for programming the mobile application 20a. Note that the interface definition 20f is stored in a predetermined area of the auxiliary storage unit 23, which is associated with, e.g., the mobile application 20a.

The execution application specifying unit 202 acquires, e.g., the source codes 20g and the HTML file 20h of the mobile application 20a with the occurrence of the boot request by referring to the auxiliary storage unit 23. Similarly, the execution application specifying unit 202 acquires the interface definition 20f associated with the mobile application 20a. The execution application specifying unit 202 hands over, e.g., the source codes 20g, the HTML file 20h and the interface definition 20f of the mobile application 20a, which are acquired from the auxiliary storage unit 23, to the object detection unit 203.

The object detection unit 203 analyzes, e.g., the program of the mobile application 20a with the occurrence of the boot request, based on the interface definition 20f handed over from the execution application specifying unit 202. The program of the mobile application 20a is analyzed targeting on, e.g., the source codes 20g. Note that the analysis of the program of the mobile application 20a has been described in FIG. 3A.

The analysis of the mobile application 20a results in specifying the define statement to generate the object (the high-order object m2) for defining the UI processing on the source codes 20g. Specified likewise is the define statement to generate the object (the high-order object m1) for defining the data processing on the source codes 20g.

The object detection unit 203 extracts low-order processing objects (elements) instanced by the functions and the variables building up the high-order object m1 from within, e.g., the specified high-order object m1. The object detection unit 203 classified the low-order processing objects (elements) extracted from, e.g., the high-order object m1 as “model object”, thereby generating the table m3 illustrated in FIG. 3A.

Similarly, the object detection unit 203 extracts low-order processing objects (elements) instanced by the functions and the variables building up the high-order object m2 from within, e.g., the specified high-order object m2. The object detection unit 203 classified the low-order processing objects (elements) extracted from, e.g., the high-order object m2 as “viewmodel object”, thereby generating the table m4 illustrated in FIG. 3A.

The object detection unit 203 temporarily stores, e.g., the generated table m3 of the “model object” and the generated table m4 of “viewmodel object” in the predetermined areas of the main storage unit 22 by being associated with the identifying information of the mobile application 20a. The object detection unit 203 hands over the generated table m3 of the “model object” and the generated table m4 of “viewmodel object” to, e.g., the UI data process extraction unit 204 by being associated with the HTML file 20h.

The UI data process extraction unit 204 checks, e.g., the low-order processing objects (elements) instanced by the functions and the variables, which are classified in the tables m3, m4 handed over from the object detection unit 203, against the HTML file 20h. Extracted as a result of checking are the elements instanced by the functions and the variables in the tables m3, m4, which are described in the HTML file 20h.

For example, the UI data process extraction unit 204 integrates and modularizes, as the UI processing module 20b, the elements in the tables m3, m4, which are extracted as the element names described in the HTML file 20h. Note that the UI data process extraction unit 204, e.g., the integrates and modularizes, as the data processing module 20c, the elements in the tables m3, m4, which are extracted as the element names not described in the HTML file 20h.

Through the modularization, the mobile application 20a is separated into the UI processing module 20b and the data processing module 20c, and is redefined to be executable. Note that the extraction and the modularization of the elements in the tables m3, m4 on the basis of the check against the HTML file 20h have been described in FIG. 3A.

The UI data process extraction unit 204 temporarily stores, e.g., the generated UI processing module 20b and the generated data processing module 20c in the predetermined areas of the main storage unit 22 by being associated with the identifying information of the mobile application 20a. The UI data process extraction unit 204 hands over, e.g., the generated UI processing module 20b and the generated data processing module 20c to the IF proxy providing unit 205.

The IF proxy providing unit 205 provides the IF proxies 20i, e.g., to the UI processing module 20b and the data processing module 20c handed over from the UI data process extraction unit 204. The IF proxy 20i is provided, e.g., per mobile application 20a.

The IF proxy 20i is a program for transferring and receiving the data between the UI processing module 20b transferred to the information processing terminal 10 and the data processing module 20c retained by the server 20. The UI processing module 20b is provided with the IF proxy 20i and is thereby enabled to perform the bidirectional communications pertaining to the process of executing the low-order objects (elements) with the data processing module 20c. Note that the description of providing the IF proxy 20i has been made in FIG. 3B.

The IF proxy providing unit 205 hands over, e.g., the UI processing module 20b and the data processing module 20c each provided with the IF proxy 20i to the module management unit 206.

The module management unit 206 manages, e.g., the execution of the UI processing module 20b and the data processing module 20c each handed over from the IF proxy providing unit 205. The module management unit 206 transfers, e.g., the UI processing module 20b provided with the IF proxy 20i to the information processing terminal 10 via the communication unit 26.

Similarly, the module management unit 206 hands over, e.g., the data processing module 20c provided with the IF proxy 20i to the mobile application execution unit 207. Note that the module management unit 206 manages, e.g., the IF proxy 20i provided per mobile application 20a by being associated with the identifying information instanced by a name of the mobile application 20a.

The mobile application execution unit 207 executes, e.g., a Process of each of the elements contained in the data processing module 20c handed over from the module management unit 206. For instance, the mobile application execution unit 207 is notified of a processing request, given from the UI processing module 20b transferred to the information processing terminal 10, of the Process of each of the elements contained in the data processing module 20c via the IF proxy transmitting/receiving unit 208.

The mobile application execution unit 207 executes, e.g., the Process, matching with the processing request, of the element in the data processing module 20c, based on the notification given via the IF proxy transmitting/receiving unit 208. The mobile application execution unit 207 hands over, e.g., as a return value, an execution result of the element contained in the data processing module 20c to the IF proxy transmitting/receiving unit 208. The execution result (return value) handed over to the IF proxy transmitting/receiving unit 208 is transmitted to the information processing terminal 10 via the communication unit 26.

Note that the operation information acquiring unit 201 hands over, to the mobile application execution unit 207, the operation input information acquired from the information processing terminal 10 currently executing, e.g., the mobile application 20a in distribution. The mobile application execution unit 207 reflects, e.g., the operation input information handed over from the operation information acquiring unit 201 in the Process of each of the elements within the data processing module 20c.

(Information Processing Terminal)

In the explanatory diagram illustrated in FIG. 5, upon the occurrence of the boot request of the mobile application 20a, the execution application specifying unit 101 specifies and transmits, e.g., the identifying information of the mobile application 20a to the server 20 together with the boot request. The identifying information and the boot request of the mobile application 20a are transmitted to the server 20 via, e.g., the communication unit 16.

The server 20 receives the boot request and other equivalent requests transmitted from the information processing terminal 10, and transfers the UI processing module 20b, to be executed in distribution, of the mobile application 20a with the occurrence of the boot request. The UI processing module 20b is provided with the IF proxy 20i for transferring and receiving the data to and from the data processing module 20c executed by the server 20.

The UI processing module receiving unit 102 of the information processing terminal 10 acquires, e.g., the UI processing module 20b, transferred by the server 20, of the mobile application 20a via the communication unit 16. The UI processing module receiving unit 102 temporarily stores, e.g., the acquired UI processing module 20b in the predetermined area of the main storage unit 13. The UI processing module receiving unit 102 hands over, e.g., the acquired UI processing module 20b of the mobile application 20a to the mobile application execution unit 103.

The mobile application execution unit 103 executes, e.g., in distribution the UI processing module 20b of the mobile application 20a, the module 20b being handed over from the UI processing module receiving unit 102. The mobile application execution unit 103 deploys, e.g., the UI processing module 20b provided with the IF proxy 20i in the executable manner onto the working area of the main storage unit 13, and executes the function of the mobile application 20a distributed into the UI processing module 20b.

The UI processing module 20b is executed asynchronously with the data processing module 20c executed by the server 20. The execution of the mobile application 20a distributed into the UI processing module 20b results in displaying, e.g., the screen defined by the HTML file 20h on an image display unit serving as the display device instanced by the LCD 15a.

The information processing terminal 10 accepts, e.g., the operation input on the screen, displayed on the LCD 15a, of the mobile application 20a running in progress via an operation information acquiring unit serving as the input unit 14. The mobile application execution unit 103 is notified of the operation input, accepted via the input unit 14, about the display on the screen of the mobile application 20a running in progress.

The mobile application execution unit 103 reflects the operation input notified from the operation information acquiring unit serving as the input unit 14 in the UI processing module 20b currently executed in distribution. The operation input on the screen displayed on the LCD 15a and other equivalent displays of the information processing terminal 10, is processed in synchronization with the UI processing module 20b.

The mobile application execution unit 103 reflects the operation input instanced by a pressing operation on a display component like an operation button displayed on the display screen and a data input in the UI processing module 20b currently executed in distribution. Alternatively, the mobile application execution unit 103 reflects, e.g., the data inputted from the vital sensor 30a and other equivalent sensors connected via the communication unit 16 in the UI processing module 20b currently executed in distribution.

Within the UI processing module 20b, each of the elements (low-order objects) instanced by the functions and the variables associated with the operation inputs described above, causes the occurrence of the processing request for the data based on the operation input. The Process of the element causing the occurrence of the data processing request within the UI processing module 20b, hands over an argument (parameter) pertaining to the data processing to the IF proxy 20i.

For example, the mobile application execution unit 103 hands over, to the IF proxy transmitting/receiving unit 104, the argument handed over to the IF proxy 20i from the UI processing module 20b executed in progress. The IF proxy transmitting/receiving unit 104 transmits, e.g., the argument of the Process with the occurrence of the processing request to the server 20 via the communication unit 16.

In the server 20, for instance, the data processing module 20c of the mobile application 20a with the occurrence of the boot request is executed in distribution by the mobile application execution unit 207. The IF proxy transmitting/receiving unit 208 receives, e.g., via the communication unit 26, the argument of the Process occurring due to the element instanced by the function and the variable of the UI processing module 20b with the occurrence of the processing request. The IF proxy transmitting/receiving unit 208 hands over the argument of the Process occurring due to the element instanced by the function and the variable of the UI processing module 20 to the mobile application execution unit 207.

The mobile application execution unit 207 reflects the handed-over argument of the Process occurring due to the element instanced by the function and the variable of the UI processing module 20 in the data processing module 20c currently executed in distribution. For example, the element within the data processing module 20c serves to execute the Process of the data processing based on the handed-over argument, this element corresponding to the processing request occurring due to the element in the UI processing module 20b. The execution of the Process of the data processing results in generating the return value with respect to the handed-over argument. The mobile application execution unit 207 hands over, e.g., the generated return value to the IF proxy transmitting/receiving unit 208 as a result of the execution of the Process of the element with the occurrence of the processing request. The UI data process extraction unit 204 of the server 20 transmits, e.g., via the communication unit 26, the return value of the Process with the occurrence of the processing request to the information processing terminal 10.

The IF proxy transmitting/receiving unit 104 of the information processing terminal 10 receives, e.g., via the communication unit 16, the return value transmitted from the server 20. The IF proxy transmitting/receiving unit 104 hands over the received return value to the mobile application execution unit 103.

The mobile application execution unit 103 reflects the return value received by the IF proxy transmitting/receiving unit 104 in the UI processing module 20b executed in progress via the IF proxy 20i. The element instanced by the function and the variable causing the occurrence of the data processing request within the UI processing module 20b, serves to continue the Process executed in progress based on, e.g., the return value. As a result, for instance, the screen displayed on the display device instanced by the LCD 15a accepts the reflection of the data input and other equivalent inputs of the user and is thereby updated.

For example, the display screen of the mobile application 20a executed in progress is switched over corresponding to the operation of pressing the display component instanced by the operation button displayed on the display screen. For instance, the processing result based on the data with the operation input being made is displayed on the display screen as an updated screen. Alternatively, the history data and other equivalent data are inputted from the vital sensor 30a and other equivalent sensors, in which case specified items of information, extracted from within the history data, e.g., a transition of blood pressure value and a history of dosage for a fixed period are displayed on the display screen as the updated screen.

[Processing Flow]

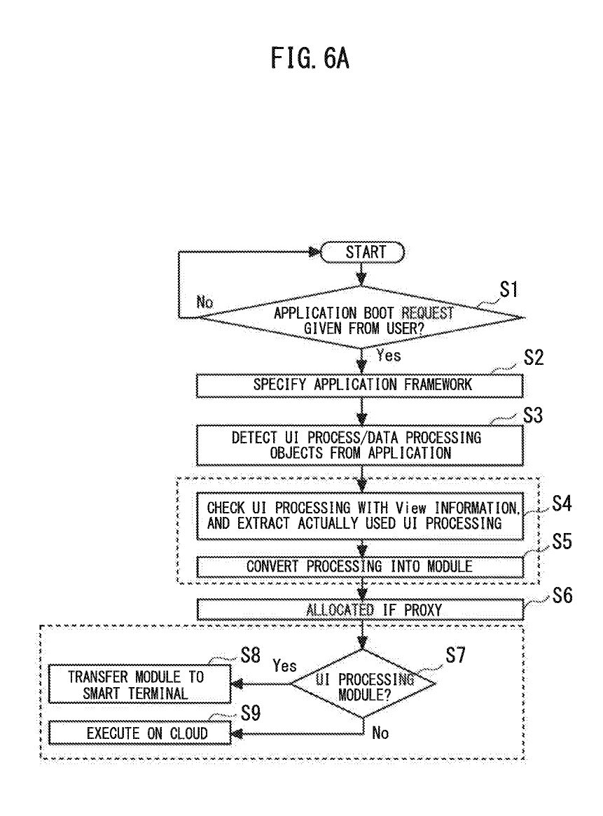

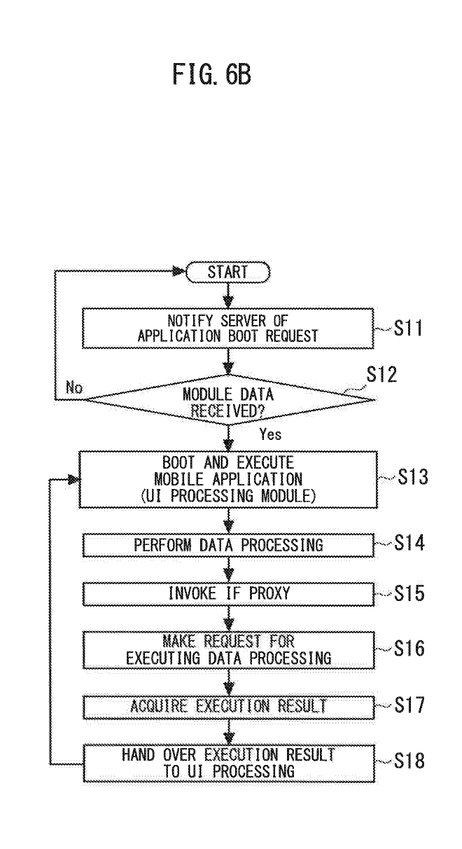

Processes pertaining to the distributed execution of the mobile application 20a of the information processing system 1 according to Embodiment 1, will hereinafter be described with reference to flowcharts illustrated in FIGS. 6A and 6B. FIG. 6A illustrates the explanatory flowchart of the processes pertaining to the distributed execution of the mobile application 20a by the server 20. FIG. 6B illustrates the explanatory flowchart of the processes pertaining to the distributed execution of the mobile application 20a by the information processing terminal 10.

The information processing terminal 10 executes the processes illustrated in FIG. 6B by using the computer program deployed in the executable manner on the RAM and other equivalent memories of the main storage unit 13. Similarly, the server 20 executes the processes illustrated in FIG. 6A by using the computer program deployed in the executable manner on, e.g., the main storage unit 22.

Note that the server 20 executing the processes illustrated in FIG. 6A is the cloud server connected via the network N, and is installed with the mobile application 20a executable by the information processing terminal 10. However, the server 20 executing the functions of the mobile application 20a in distribution to the information processing terminal 10, is the cloud server connected via the IF proxy 20i to the information processing terminal 10. The information processing terminal 10 and the server 20, which are interconnected via the IF proxy 20i, execute in distribution the functions of the mobile application 20a in, e.g., a server/client mode.

(Server)

In the flowchart depicted in FIG. 6A, a start of the processes pertaining to the distributed execution of the mobile application 20a of the server 20 can be exemplified as being triggered by establishing the connection to the network N to which the information processing terminal 10 connects.

The server 20 determines, e.g., whether the boot request for the mobile application 20a is given from the information processing terminal 10 connecting to the network N (S1). The server 20 advances to a process in S2 when the boot request for the mobile application 20a is given (S1, Yes). Whereas when the boot request for the mobile application 20a is not given (S1, No), the server 20 stands by till receiving the boot request.

In the process of S2, the server 20 specifies, e.g., the framework 20e of the mobile application 20a with the boot request being given. The server 20 acquires, e.g., the interface definition 20f associated with the mobile application 20a, based on the identifying information instanced by the name and other equivalent information of the mobile application 20a and the specified framework 20e. The interface definition 20f is stored in, e.g., the predetermined area of the auxiliary storage unit 23. The server 20 hands over the acquired interface definition 20f together with the identifying information of the mobile application 20a to a process in S3.

In the process of S3, the server 20 analyzes, e.g., the source codes 20g of the mobile application 20a, based on the interface definition 20f, thereby detecting the elements (low-order objects) instanced by the functions and the variables associated with the UI processing and the data processing. The process in S3 has been described in FIG. 3A. Note that the elements instanced by the functions and the variables will be also referred to as “element objects” in the following discussion.

In the process of S3, the table m3 classified as “model object” and the table m4 classified as “viewmodel object” illustrated in FIG. 3A are generated as a result of the detection. The server 20 temporarily stores, e.g., the table m3 of the generated “model object” and the table m4 of the generated “viewmodel object” in the predetermined areas of the main storage unit 22 by being associated with the identifying information of the mobile application 20a. The server 20 hands over, e.g., the table m3 of the generated “model object” and the table m4 of the generated “viewmodel object” to a process in S4.

In the process of S4, the server 20 checks, e.g., View information against the element objects instanced by the functions and the variables classified in the tables m3 and m4, and extracts the element objects of the UI processing, which are utilized as View information. Herein, “View information” is a program to describe the screen displayed on the LCD 15a and other equivalent displays of the information processing terminal 10, and is described by the Markup language instanced by HTML, XML and XAML.

The server 20 checks, e.g., the character strings described in the HTML file 20h of the mobile application 20a against the names of the element objects classified within the tables m3 and m4. The server 20 extracts, e.g., the element objects already described in the HTML file 20h as the element objects to be used for the UI processing. Similarly, the server 20 extracts, e.g., the element objects not described in the HTML file 20h as the element objects to be used for the data processing. Note that the server 20 may also extract other element objects excluding the element objects to be used for the UI processing as the element objects to be used for the data processing.

In the process of S5, the server 20 generates the UI processing module 20b by integrating and modularizing, e.g., the element objects, extracted in the process of S4, to be used for the UI processing. Similarly, the server 20 generates the data processing module 20c by integrating and modularizing, e.g., the element objects, extracted in the process of S4, to be used for the data processing. The process in S5 causes the mobile application 20a to be separated into the UI processing module 20b and the data processing module 20c and redefined (converted) in the executable manner.

In the process of S6, the server 20 provides, e.g., the IF proxies 20i respectively to the UI processing module 20b and the data processing module 20c generated in the process of S5. The IF proxy 20i has been described in FIG. 3B and other equivalent drawings. The IF proxy 20i is provided, e.g., per mobile application 20a. The server 20 manages, e.g., the provided IF proxy 20i by being associated with the mobile application 20a.

The IF proxies 20i are provided, thereby enabling the bidirectional communications pertaining to the process of executing the element objects between the UI processing module 20b executed separately by the information processing terminal 10 and the data processing module 20c executed separately by the server 20.

In the process of S7, the server 20 determines, e.g., whether the processing module provided with the IF proxy 20i in the process of S6 is the UI processing module 20b. The server 20 advances to the process in S8 when the processing module provided with the IF proxy 20i in the process of S6 is the UI processing module 20b (S7, Yes). Whereas when the processing module provided with the IF proxy 20i in the process of S6 is not the UI processing module 20b (S7, No), the server 20 diverts to the process in S9.

In the process of S8, the server 20 transfers, e.g., the UI processing module 20b provided with the IF proxy 20i to the information processing terminal 10 with the occurrence of the boot request for the mobile application 20a. The server 20 transfers, e.g., the UI processing module 20b provided with the IF proxy 20i together with the identifying information instanced by the name of the mobile application 20a to the information processing terminal 10.

The UI processing module 20b provided with the IF proxy 20i, which has been transferred to the information processing terminal 10, is received via the communication unit 16 and temporarily stored in, e.g., the predetermined area of the main storage unit 13. The information processing terminal 10 deploys, e.g., the UI processing module 20b provided with the IF proxy 20i in the executable manner on the working area of the main storage unit 13, thereby executing the functions, distributed to the UI processing module 20b, of the mobile application 20a.

On the other hand, in the process of S9, the server 20 temporarily stores, e.g., the data processing module 20c provided with the IF proxy 20i in the predetermined area of the main storage unit 22. The server 20 deploys, e.g., the data processing module 20c provided with the IF proxy 20i in the executable manner on the working area of the main storage unit 22, thereby executing the functions, distributed to the data processing module 20c, of the mobile application 20a.

The functions of the mobile application 20a, which are separated into the UI processing module 20b and the data processing module 20c, are asynchronously executed in distribution by using the respective resources of the information processing terminal 10 and the server 20.

Note that the discussion in FIG. 6A has been made on the assumption that the execution of the processes in S2-S5 is triggered by receiving the boot request for the mobile application 20a from the information processing terminal 10. The server 20 may also, e.g., generate the UI processing module 20b and the data processing module 20c by previously executing the processes in S2-S5 with respect to the mobile application 20a installable into the information processing terminal 10. The server 20 may also provide the IF proxies 20i respectively to the UI processing module 20b and the data processing module 20c, which are previously generated upon the trigger of the boot request for the mobile application 20a, and may transfer these modules 20b, 20c to the information processing terminal 10.

The server 20 may also execute the mobile application 20a in place of executing the separated data processing module 20c. The server may hand over the argument received via the IF proxy 20i to the Process executed in progress as the associated mobile application 20a, and may obtain the return value as an execution result. It may be sufficient that the server 20 transmits the return value as the obtained execution result via the IF proxy 20i to the UI processing module 20b executed in progress on the side of the information processing terminal 10.

(Information Processing Terminal)

In the flowchart depicted in FIG. 6A, a start of the processes pertaining to the distributed execution of the mobile application 20a of the information processing terminal 10 can be exemplified as being triggered by the occurrence of the boot request for the mobile application 20a. The information processing terminal 10 can accept the operation input on the icon and other equivalent components displayed on the screen of the LCD 15a and other equivalent displays and each associated with the mobile application 20a when the boot request occurs. Alternatively, the boot request accepted from the wearable equipment connected to the information processing terminal 10 through the near field communication typified by Bluetooth (registered trademark) can be given when the boot request for the mobile application 20a occurs.

The information processing terminal 10 accepts, e.g., the boot request for the mobile application 20a, specifies the identifying information instanced by the name of the mobile application 20a, and transmits the identifying information together with the boot request to the server 20 (S11). The identifying information of the mobile application 20a and the boot request are transmitted via, e.g., the communication unit 16.

The information processing terminal 10 determines, e.g., whether the UI processing module 20b of the mobile application 20a with the boot request being made is received (S12). As described in the process of S8 in FIG. 6A, the UI processing module 20b transferred from the server 20 in response to the boot request from the information processing terminal 10, is attached with the identifying information instanced by the name of the mobile application 20a with the boot request being made. The information processing terminal 10 determines whether the UI processing module 20b received via, e.g., the communication unit 26 is attached with the identifying information instanced by the name of the mobile application 20a with the boot request being made.

The information processing terminal 10 advances to, e.g., the process in S13 when the received UI processing module 20b is attached with the identifying information instanced by the name of the mobile application 20a with the boot request being made. Whereas when the received UI processing module 20b is not attached with the identifying information instanced by the name of the mobile application 20a with the boot request being made, the information processing terminal 10 stands by, e.g., till receiving the UI processing module 20b.

In the process of S13, the information processing terminal 10 temporarily stores, e.g., the received UI processing module 20b together with the provided IF proxy 20i in the predetermined area of the main storage unit 13. The information processing terminal 10 deploys, e.g., the UI processing module 20b provided with the IF proxy 20i in the executable manner on the working area of the main storage unit 13, thereby executing the functions, distributed to the UI processing module 20b, of the mobile application 20a. The execution of the UI processing module 20b causes the screen defined in, e.g., the HTML file 20h to be displayed on the display device instanced by the LCD 15a of the information processing terminal 10.

The information processing terminal 10 accepts, e.g., the operation input on the screen displayed by executing the UI processing module 20b. The information processing terminal 10 accepts, e.g., the operation of pressing the display component instanced by the operation button displayed on the screen, and the operation input instanced by the data input. Alternatively, the information processing terminal 10 accepts the input of the data read from the vital sensor 30a and other equivalent sensors connected via the communication unit 26. The information processing terminal 10 reflects the accepted operation input in the UI processing module 20b executed in progress.

Each of the element objects instanced by the functions and the variables associated with the foregoing operation inputs within the UI processing module 20b, causes the occurrence of the data processing request based on the operation input (S14). The Process of the element object causing the occurrence of the data processing request invokes the IF proxy 20i allocated to the UI processing module 20b, and hands over the argument (parameter) pertaining to the data processing to the IF proxy 20i (S15).

The IF proxy 20i allocated to the UI processing module 20b requests the data processing module 20c currently executed in distribution on the side of the server 20 to execute the data processing on the basis of Communication Standards exemplified by “WebSocket” (S16).

The data processing module 20c currently executed in distribution in the server 20 acquires the argument of the Process of the element object causing the occurrence of the data processing request via the IF proxy 20i allocated to the data processing module 20c. The element object associated with the processing request in the data processing module 20c of the server 20 executes the Process in which the argument is reflected, and hands over an execution result as the return value to the IF proxy 20i.

The IF proxy 20i allocated to the data processing module 20c transmits, based on the Communication Standards exemplified by “WebSocket”, the execution result (return value) to the UI processing module 20b currently executed in distribution on the side of the information processing terminal 10.

The IF proxy 20i allocated to the UI processing module 20b currently executed in distribution on the side of the information processing terminal 10, acquires the execution results transmitted from the data processing module 20c currently executed in distribution on the side of the server 20 (S17). The IF proxy 20i allocated to the UI processing module 20b hands over the acquired execution result (return value) to the Process of the element object in the UI processing module 20b causing the occurrence of the data processing request.

The element object causing the occurrence of the data processing request within the UI processing module 20b continues the Process executed in progress based on the execution result (return value) handed over from the IF proxy 20i. The post-updating display screen updated with the operation input is displayed on the LCD and other equivalent displays of the information processing terminal 10.

Herein, the processes in S2-S5 executed by the server 20 are one examples of “analyzing processing codes in a program”, “extracting one or more processing codes describing a screen of the program”, and “generating a processing code group for screen processing by combining one or more extracted processing codes in a manner of being executable by an electronic equipment”. The CPU 21 and other equivalent processors of the server 20 execute the processes in S2-S5 as one example of “to generate a processing code group for screen processing by combining one or more extracted processing codes in a manner of being executable by an electronic equipment”.

The processes in S7-S9 executed by the server 20 are one examples of “transmitting the processing code group for the screen processing to the electronic equipment”, “accepting a processing request from the one or more extracted processing codes contained in the processing code group for the screen processing executed by the electronic equipment”, “executing the processing codes excluding the processing code group for the screen processing in the program”, and “transmitting execution results of the processing codes, associated with the processing requests, in the program to the electronic equipment”. The CPU 21 and other equivalent processors of the server 20 execute the processes in S7-S9 as one example of “to transmit the processing code group for the screen processing to the electronic equipment, to execute the processing codes excluding the processing code group for the screen processing in the program upon accepting processing requests from the one or more extracted processing codes contained in the processing code group for the screen processing executed by the electronic equipment, and to transmit execution results of the processing codes, associated with the processing requests, in the program to the electronic equipment”.

The process in S6 executed by the server 20 is one example of “allocating the processing code group for the screen processing with a relay program to perform communications with processing codes excluding the processing code group for the screen processing in the program”. The CPU 21 and other equivalent processors of the server 20 execute the process in S6 as one example of “to allocate the processing code group for the screen processing with a relay program to perform communications with the processing codes excluding the processing code group for the screen processing in the program”.

The processes in S11-S12 executed by the information processing terminal 10 are one examples of “accepting a processing code group for screen processing, the processing code group being generated by extracting one or more processing codes describing a screen of a program”. The CPU 11 and other equivalent processors of the information processing terminal 10 execute the processes in S11-S12 as one example of “to accept a processing code group for screen processing, the processing code group being generated by extracting one or more processing codes describing a screen of a program”.

The process in S15 executed by the information processing terminal 10 is one example of “receiving a relay program to perform communications with processing codes excluding the processing code group for the screen processing in the program allocated to the processing code group for the screen processing”. The CPU 11 and other equivalent processors of the information processing terminal 10 execute the process in S15 as one example of “to receive a relay program to perform communications with processing codes excluding the processing code group for the screen processing in the program, the relay program allocated to the processing code group for the screen processing”.

The processes in S13-S18 executed by the information processing terminal 10 are one examples of “transmitting respective processing requests concomitant with execution of the processing code group for the screen processing to an information processing apparatus”, “acquiring results of processes associated with the respective processing requests”, and “a processing step of generating a screen of a program, based on the results of the processes”. The CPU 11 and other equivalent processors of the information processing terminal 10 execute the processes in S13-S18 as one example of “to generate a screen of a program by transmitting respective processing requests concomitant with execution of the processing code group for the screen processing to an information processing apparatus, and by acquiring results of processes associated with the respective processing requests”.

As described above, the server 20 according to Embodiment 1 can separate the application program installable in the information processing terminal 10 into the UI processing module and the data processing module. For example, the server 20 can extract, as the UI processing module, the element objects instanced by the functions and the variables declared in the define statement for defining the display screen provided as being concomitant with the execution of the application in the application program. Similarly, the server 20c can extract, as the data processing module., the element objects instanced by the functions and the variables in the application program excluding the UI processing module. The server 20 can provide the extracted UI processing module and the data processing module with the proxy programs enabling the bidirectional communications between the respective modules in the way of being concomitant with the execution of the processes.

As a result, the information processing system 1 according to Embodiment 1 asynchronously executes the UI processing module distributed to the information processing terminal 10 and the data processing module distributed to the server 20, thereby enabling the functions of the application to be provided. The information processing system 1 can execute the process of the highly confidential information instanced by the individual information pertaining to utilizing, e.g., the services as the process on the side of the server 20. It is therefore feasible to enhance the security of the highly confidential information against the loss of the information processing terminal 10, and the leakage of the information.

The information processing system 1 according to Embodiment 1 can also execute the processes, concomitant with the execution of the application, on the display screen as the UI processing module of the information processing terminal 10. Hence, e.g., the processes instanced by operation inputs on the display screen can be executed in synchronization with the UI processing module. The information processing system 1 according to Embodiment 1 can substantially enhance the operating responsiveness on the display screen, which is concomitant with the execution of the application. The information processing system. 1 according to Embodiment 1 is compatible with both ensuring the security of the information pertaining to utilizing the services of the information processing terminal 10 and ensuring the operating responsiveness.

### Embodiment 2

The information processing system 1 according to Embodiment 1 separates the program of the mobile application 20a into the UI processing module 20b and the data processing module 20c, and distributes the UI processing module 20b and the data processing module 20c to the information processing terminal 10 and the server 20, thus asynchronously executing these modules. The IF proxies 20i are provided to the UI processing module 20b and the data processing module 20c. the processing modules distributed to the information processing terminal 10 and the server 20 transfer and receive the data mutually via the IF proxies 20i, thereby providing the functions of the mobile application 20a.

In the information processing system 1 according to a second embodiment (which will hereinafter be termed Embodiment 2), the server 20 further provides, e.g., object managers to the separated processing modules. As already described, the element objects instanced by the functions and the variables declared in the define statement for defining the screen provided as being concomitant with the execution of the application, are classified in the UI processing module 20b.

The object manager periodically measures, e.g., access performances of the function elements in the element objects classified in the UI processing module 20b. The access performance is measured, e.g., per function element. Note that a cycle of measuring the access performance can be set based on, e.g., performances of the respective equipments configuring the information processing system 1, the functions of the mobile application, and other equivalent capabilities. A minute-basis, an hour-basis and other equivalent bases can be exemplified as the measuring cycle of the access performance.

The access performance measured by the object manager contains a “data reference count” by which each function element invokes the data processing module 20c executed on the side of the server 20. Similarly, the access performance contains a period of” execution delay time” till each function element accepts the return value of the execution result since the function element has caused the occurrence of the processing request.

The object manager compares the measured access performance of each function element with a predetermined threshold value, and thus determines a relative relationship between the access performance and the predetermined threshold value. The object manager determines a migration of the function element between the processing modules, corresponding to the determined relative relationship between the access performance of each function element and the predetermined threshold value. The migration of the function element between the processing modules includes, e.g., a migration from the data processing module 20c to the UI processing module 20b, and a migration from the UI processing module 20b to the data processing module 20c.

The information processing system 1 according to Embodiment 2 can implement the migration of every function element between the processing modules, corresponding to a usage environment instanced by a usage frequency of the mobile application 20a utilized for the services and a communication status under the mobile environment. The information processing system 1 according to Embodiment 2 can provide the operating responsiveness matching with the usage environment of the application functions.

(Object Manager)

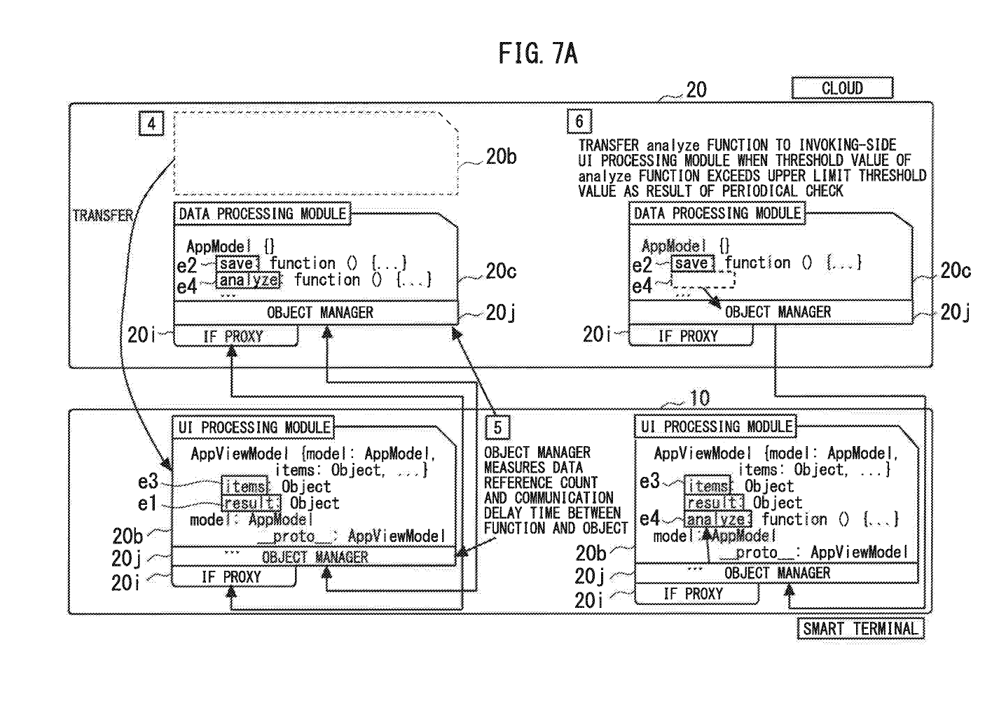

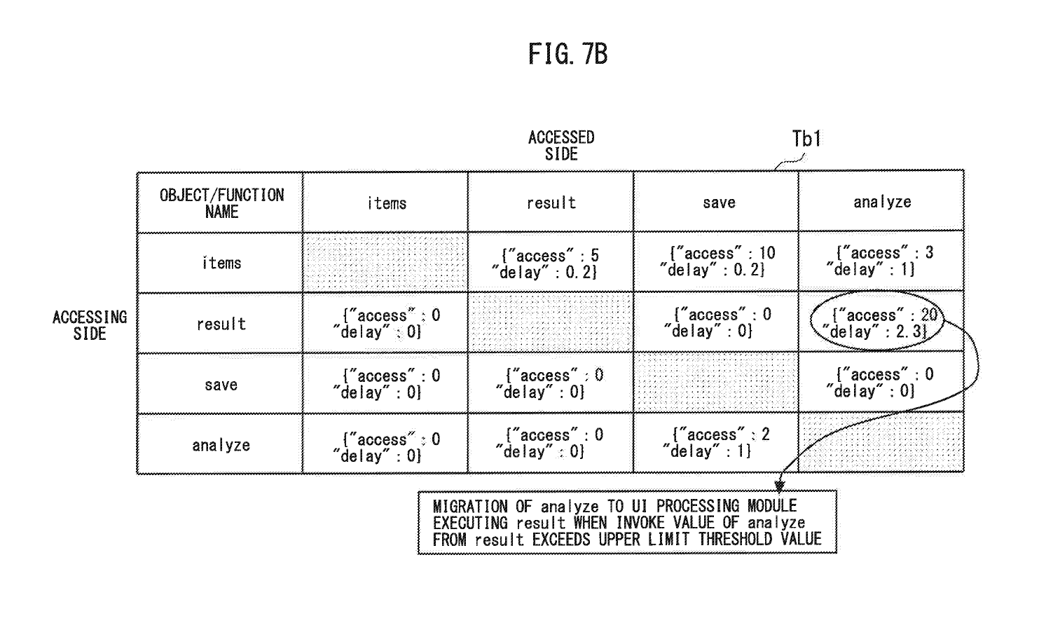

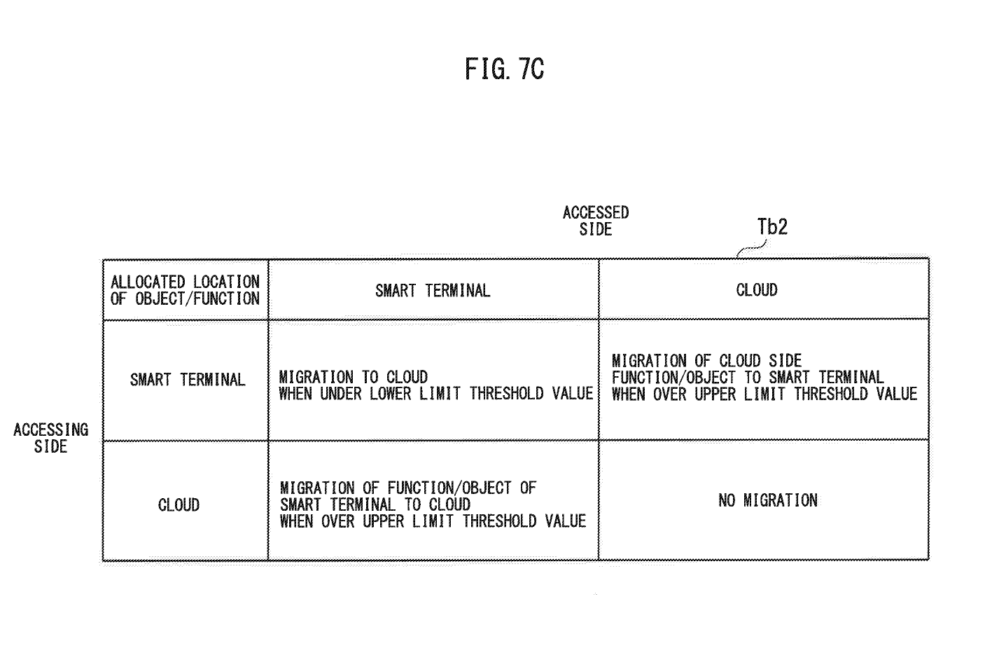

Processes of the object manager according to Embodiment 2 will hereinafter be described with reference to drawings illustrated in FIGS. 7A-7C. Note that hardware configurations of the information processing terminal 10 and the server 20 according to Embodiment 2 are the same as those in Embodiment 1.

FIG. 7A illustrates an explanatory diagram of the processes of the object manager. Note that in the explanatory diagram illustrated in FIG. 7A, the components common to the explanatory diagram of the processes in Embodiment 1 illustrated in FIGS. 3A, 3B are marked with the same numerals and symbols, and their explanations are omitted. A process of separating the mobile application 20a into the UI processing module 20b and the data processing module 20c on the source codes is the same as the separating process according to Embodiment 1 illustrated in FIG. 3A.

In the explanatory diagram of FIG. 7A, as indicated by 4 surrounded in a rectangular shape, the UI processing module 20b separated from the mobile application 20a is allocated with the IF proxy 20i and an object manager 20j, and is thus transferred to the information processing terminal 10. The data processing module 20c separated from the mobile application 20a is also allocated with the IF proxy 20i and the object manager 20j, and is thus retained by the server 20.

The UI processing module 20b distributed to and executed by the information processing terminal 10 transfers and receives the data to and from the data processing module 20c distributed to and executed by the server 20 via the IF proxy 20i. The element objects instanced by the functions and the variables declared in the define statement (e.g., HTML) for defining the display screen displayed on the display device instanced by the LCD 15a, are classified in the UI processing module 20b.

The object manager 20j measures the access performances, when executing the Process, of the function elements classified respectively in the UI processing module 20b and the data processing module 20c. The access performance is measured per function element.

For example, the processing request occurring in the Process of the function element of the UI processing module 20b is transmitted to the element object associated with the processing request within the data processing module 20c via the IF proxy 20i. A result (return value) about the processing request from the data processing module 20c is handed over to the function element with occurrence of the processing request within the UI processing module 20b via the IF proxy 20i.

The object manager 20j monitors the access, to the IF proxy 20i, of each function element within the processing module, and thus measures the access performance described above. For example, an assumption is that each of the function elements within the UI processing module 20b causes the occurrence of the processing request for the data processing module 20c.

The object manager 20j measures, e.g., a processing request count for the data processing module 20c as the “data reference count”. In the “data reference count”, the function element causing the occurrence of the processing request within the UI processing module 20b is associated with the function element within the data processing module 20c, which accepts the processing request of the function and transmits a processing result (return value).

The object manager 20j measures, as “execution delay time”, a period of time till each function element receives the result (return value) with respect to the processing request since the function element has caused the occurrence of the processing request. Similarly to the “data reference count”, in the “execution delay time”, the function element causing the occurrence of the processing request is associated with the function element transmitting the processing result (return value).

For example, the object manager 20j allocated to the UI processing module 20b measures, as the “execution delay time”, a period of time till each function element within the UI processing module 20b receives the result (return value) with respect to the processing request since the function element has caused the occurrence of the processing request.

The function element giving a response of the result (return value) with respect to the generated processing request contains, e.g., the function element, with the Process being executed on the side of the server 20, of the data processing module 20c. The “execution delay time” in this case is a period of time till receiving the result (return value) with respect to the processing request via the IF proxy 20i since the processing request has occurred.

The function element giving the response of the result (return value) with respect to the processing request occurred contains, e.g., the function element with the Process being executed in the information processing terminal 10 after the migration from the data processing module 20c. The “execution delay time” in this case is a period of time till the function element causing the occurrence of the processing request receives the result (return value) with respect to the processing request since the processing request has occurred. In this case, however, the object manager 20j, e.g., may measure, as the “data reference count”, a processing request count for the function element after the migration from the data processing module 20c.

The same is applied to the object manager 20j allocated to the data processing module 20c. For instance, the object manager 20j monitors the access, to the IF proxy 20i, of each function element within the data processing module 20c executed in progress, thus measuring the access performance.

For example, each function element within the UI processing module 20b causes the occurrence of the processing request for the data processing module 20c, in which case the object manager 20j measures, e.g., the processing request count of the data processing module 20c as the “data reference count”.

The following is the “execution delay time” measured by the object manager 20j. The “execution delay time” is a period of time till the function element within the data processing module 20c transmits the result (return value) with respect to the processing request since each function element within the UI processing module 20b has received the generated processing request via the IF proxy 20i.

Note that the following are details of the case in which the processing request for the function element with the Process being executed within the information processing terminal 10 occurs after the migration from the data processing module 20c. To be specific, the “data reference count” is the processing request count for the UI processing module 20b. The “execution delay time” is measured as a period of time till receiving the result (return value) with respect to the processing request via the IF proxy 20i since when each function element within the data processing module 20c has generated the processing request.

The object manager 20j allocated to the data processing module 20c associates the function elements generating the processing requests with the function elements accepting the processing requests of the function elements and transmitting the processing results (return values) in the “data reference count” and the “execution delay time”.

The object manager 20j generates, e.g., a table, on the basis of the measured access performances. FIG. 7B illustrates a table Tb1 generated based on the measured access performances. The table Tb1 illustrated in FIG. 7B is an example of, e.g., the table generated by the object manager 20j allocated to the data processing module 20c. The table Tb1 illustrated in FIG. 7B is an example of the measurement by the object manager 20j allocated to the data processing module 20c before the migration of the function element occurs.

In the example of the table Tb1 in FIG. 7B, the names of the function elements making the processing requests are arrayed in lengthwise columns, while the names of the function elements giving the responses of the results to the processing requests are arrayed in crosswise columns.

Note that a plurality of processing requests for the element objects classified in the UI processing module 20b occurs in the function elements of the data processing module 20c from the different Processes. Therefore, the access performances of the plurality of function elements within the data processing module 20c are associated with the column stored with one function element name of the UI processing module 20b.

When the processing requests of the function elements classified in the UI processing module 20b occur in the data processing module 20c, the object manager 20j provides, e.g., a monitoring period, and measures the “data reference count” occurring in this monitoring period. The monitoring period may be exemplified by 60 sec immediately after the occurrence of the processing request. The monitoring period may be, however, set corresponding to the performances of the equipments included in the information processing system 1, the functions of the mobile application executed in distribution, and other equivalent capabilities.

In the table Tb1 illustrated in FIG. 7B, the measured access performances are stored in the columns in intersecting positions between the function elements arrayed lengthwise and the function elements arrayed crosswise. The measured access performances are stored in a format instanced by “{“access”:AAA “delay”:BBB}”. A value “access” embraced by “{ }” represents the “data reference count”, and a value “:AAA” indicates a measurement value. A value “delay” embraced by “{ }” represents the “execution delay time”, and a value “:BBB” indicates a measurement value on a second-basis.

In the table Tb1 in FIG. 7B, the “data reference count” is an example of the measurement when the monitoring period described above is set to 60 sec immediately after the occurrence of the processing request. The “execution delay time” is an example of the measurement when averaging the periods of “execution delay time” against the immediate “data reference count” measured ten times after the occurrence of the processing request. A method of measuring the “execution delay time” may, however, be set corresponding to the performances of the equipments included in the information processing system 1, the functions of the mobile application executed in distribution and other equivalent capabilities. For example, the measurement value can be exemplified by “maximum execution delay time” or “minimum execution delay time” in the measured “data reference count”.

In the example of the table Tb1 in FIG. 7B, the column of the function element arranged lengthwise, which is stored with “items”, is associated with the columns of the function elements arranged crosswise, which are stored with “result”, “save”, “analyze”. For instance, it is recognized that the processing requests occur in the respective function elements “result”, “save”, “analyze” classified in the data processing module 20c in the execution Process of the function element “items” classified in the UI processing module 20b.

It is recognized that the “data reference count” measured for the function element “result” in the data processing module 20c is “5”, and the “execution delay time” is “0.2 sec”. Similarly, it is recognized that the “data reference count” measured for the function element “save” is “10”, and the “execution delay time” is “0.2 sec”. It is also recognized that the “data reference count” measured for the function element “analyze” is “3”, and the “execution delay time” is “1 sec”.

It is understood that the request target element of the processing request occurring from the execution Process of the function element “items” of the UI processing module 20b is relatively high in “data reference count” of the function element “save” in the data processing module 20c. It is also understood that the “execution delay time” measured targeting on the function element “analyze” of the data processing module 20c is relatively large in the processing request occurring from the execution Process of the function element “items” of the UI processing module 20b.

The following states will be recognized when mutually comparing the respective measurement values about the function elements “items”, “result”, “save” of the UI processing module 20b, which cause the occurrence of the processing request targeted on the function element “analyze” of the data processing module 20c. The “data reference count” from the function element “result” of the UI processing module 20b is “20” and the “execution delay time” is “2.3 sec”, from which it is understood that the relatively high measurement values are stored respectively therein.

The object manager 20j determines, based on, e.g., the access performance measured per function element, the function element migrating between the UI processing module 20b and the data processing module 20c.

The function element migrating between the processing modules is determined from the relative relationship between the measured access performance and the threshold value. Note that the relative relationships with the threshold values for the determination may be retained as tabularized determination conditions.

FIG. 7C illustrates a table Tb2 that stores the determination conditions for determining the migration of the function element between the processing modules. The table Tb2 illustrated in FIG. 7C is one example of having, e.g., an upper limit value and a lower limit value as the threshold values for determining the migration of the function element between the processing modules. Note that the threshold value for determining the migration can be set based on, e.g., the performances of the respective equipments configuring the information processing system 1, the functions of the mobile application, and other equivalent capabilities. The threshold value may be singular, and three or more threshold values like an upper limit value, a median value and a lower limit value may also be available.

The object manager 20j can be expected to have the following effects by having the threshold values, i.e., the upper limit value and the lower limit value. To be specific, the measured access performance exhibits a value equal to or larger than the upper limit value, from which it can be determined that a frequency of the processing request for the function element is high. When a processing frequency for a specified function element is high, e.g., there rises a communication frequency of transferring and receiving the data between the UI processing module 20b and the data processing module 20c. When the communication frequency rises, it follows that the resources of the information processing terminal 10 are assigned to the process of transferring and receiving the data, and hence a decrease in operating responsiveness might be induced.

According to Embodiment 2, the function element with the access performance equal to or larger than the upper limit value is specified by the determination using the threshold values, thereby enabling the function element to migrate to the same location as the function element making the processing request migrates. For example, the function element exhibiting the high frequency of the processing request with the Process executed by the server 20 migrates to the information processing terminal 10 containing the function element causing the occurrence of the processing request, thereby enabling a reduction in load on the communications for transferring and receiving the data. The reduction in communication load enables the performance of the operating responsiveness to be kept and consequently enables avoidance of decreasing the operating responsiveness. It is thus feasible to provide the operating responsiveness flexible to the usage environment of the information processing terminal 10.

The function elements classified in the data processing module 20c deal with the highly confidential information as the data when executing the Process as the case may be. Therefore, the function element migrates to the information processing terminal 10 from the data processing module 20c currently executed in distribution by the server 20, in which case the security of the information might decline.

According to Embodiment 2, the setting of the lower limit value for the measured access performance enables, e.g., the determination of migration for returning the function element, having migrated to the information processing terminal 10, of the data processing module 20c back to the server 20. The security of the information can be kept for a long period of time by returning the function element, having migrated to the information processing terminal 10, of the data processing module 20c back to the server 20. It is possible to provide the information security taking account of the usage environment of the information processing terminal 10.

The threshold value serving as the upper limit value can be exemplified by such conditions that the “data reference count” in the measured access performance is equal to or larger than “3” for 10 sec, and the “execution delay time” exceeds 1.0 sec. The threshold value serving as the lower limit value can be exemplified by such a condition that the “data reference count” in the access performance is equal to or smaller than “1” for 60 sec.

In the example of the table Tb2 in FIG. 7C, the equipments executing the function elements making the processing requests via the IF proxies 20i are arrayed in the lengthwise columns, while the equipments executing the function elements giving the responses of results about the processing requests are arrayed in the crosswise columns. In the example of the table Tb2 in FIG. 7C, an entry “smart terminal” indicates the information processing terminal 10, an entry “cloud” indicates the server 20.

In the table Tb2 in FIG. 7C, the determination conditions for migrating the function elements are stored in the columns in intersecting positions between the equipments arrayed in the lengthwise columns and the equipments arrayed in the crosswise columns. For example, a determination condition “the function/object on the cloud side migrates to the smart terminal when equal to or larger than the upper limit value” is stored in the intersecting position between the column stored with the “smart terminal” in the lengthwise direction and the column stored with “cloud” in the crosswise direction.

It is recognized that the function element in the data processing module 20c migrates to the UI processing module 20b when the measured access performance of the function element classified in the UI processing module 20b to the function element classified in the data processing module 20c, is equal to or larger than the upper limit value.

For instance, in the table Tb1 illustrated in FIG. 7B, the “data reference count” to “analyze” of the data processing module 20c from “result” of the UI processing module 20b is “20”, and the “execution delay time” is “2.3 sec”.

The object manager 20j allocated to the data processing module 20c refers to the conditions stored, e.g., in the table Tb2 illustrated in FIG. 7C, and determines that the function element “analyze” is to migrate to the UI processing module 20b when the measurement value is equal to or larger than the upper limit value.

In the table Tb2 illustrated in FIG. 7C, a determination condition “migrating to cloud when equal to or smaller than the lower limit threshold value” is stored in the intersecting position between the column stored with the “smart terminal” in the lengthwise direction and the column stored with “smart terminal” in the crosswise direction.

The object manager 20j allocated to the UI processing module 20b measures the access performance to, e.g., the function element “analyze” after migrating to the information processing terminal 10. The object manager 20j then refers to the conditions stored in the table Tb2 illustrated in FIG. 7C, and thus determines the migration for returning the function element “analyze” back to the data processing module 20c when the measurement value of the measured access performance is equal to or smaller than the lower limit threshold value. The object manager 20j allocated to the UI processing module 20b can return the function element “analyze” having migrated to the information processing terminal 10 back to the server 20.

Referring back to the explanatory diagram depicted in FIG. 7A, the foregoing migration process of the function element is indicated by 6 surrounded in the rectangular shape. To be specific, the function element “analyze” is classified as the element e4 in the data processing module 20c in 4 surrounded in the rectangular shape. As described in FIGS. 7B and 7C, the function element “analyze” with the measured access performance being equal to or larger than the upper limit value migrates to the information processing terminal 10. The object manager 20j allocated to the data processing module 20c carries out the migration of the function element “analyze”.

The object manager 20j specifies and acquires the function element “analyze” from within, e.g., the data processing module 20c. Then, the object manager 20j transfers the acquired function element “analyze” to the information processing terminal 10. The function element “analyze” is transferred via, e.g., the communication unit 26.

The object manager 20j allocated to the UI processing module 20b receives, via the communication unit 16, the function element “analyze” transferred from the server 20. The object manager 20j combines the received function element “analyze” with the UI processing module 20b. The information processing terminal 10 executes the UI processing module 20b combined with the function element “analyze”.

Note that the object manager 20j allocated to the UI processing module 20b may attach an identifier used for measuring the access performance to the function element “analyze”. The object manager 20j can continuously measure, based on the identifier attached to the function element “analyze”, a post-migrating access performance.

[Configuration of Processing Blocks]

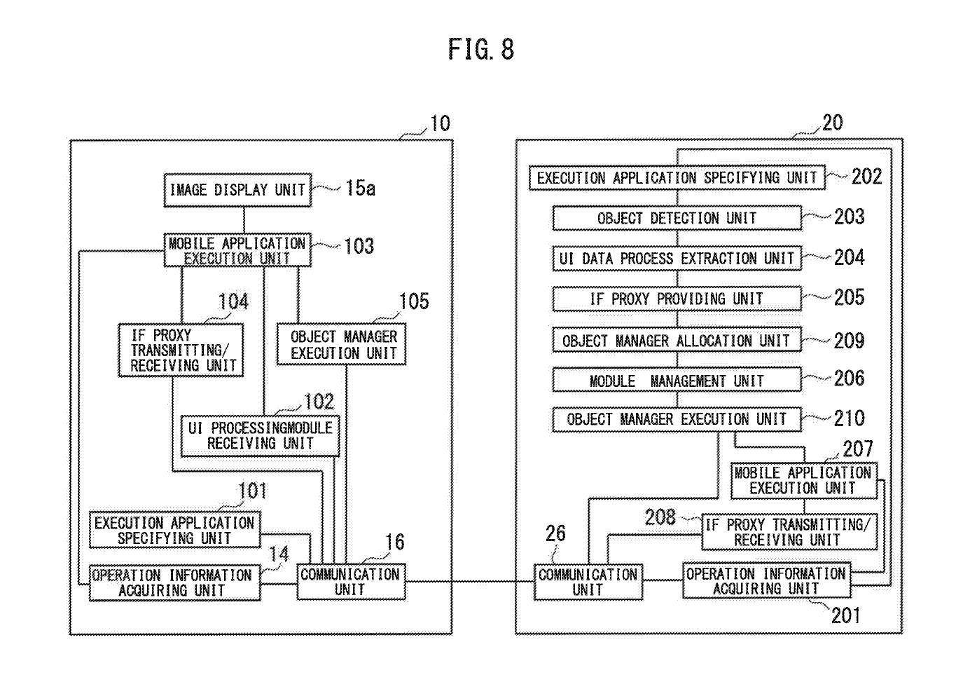

FIG. 8 illustrates an explanatory diagram of processing blocks in the information processing system 1 according to Embodiment 2. Note that in the explanatory diagram illustrated in FIG. 8, components common to those in the explanatory diagram of the processing blocks according to Embodiment 1 illustrated in FIG. 5 are marked with the same numerals and symbols, and their explanations are omitted.

As depicted in FIG. 8, the information processing terminal 10 of the information processing system 1 according to Embodiment 2 includes a processing function, i.e., an object manager execution unit 105 as an additional component to the configuration of the processing blocks according to Embodiment 1. The server 20 also includes processing functions, i.e., an object manager allocation unit 209 and an object manager execution unit 210 as additional components to the configuration of the processing blocks according to Embodiment 1.

(Server)

In the explanatory diagram illustrated in FIG. 8, the object manager allocation unit 209 allocates the object managers 20j to, e.g., the UI processing module 20b and the data processing module 20c each allocated with the IF proxy 20i. The object manager allocation unit 209 hands over, to the module management unit 206, the UI processing module 20b and the data processing module 20c each allocated with the object manager 20j and the IF proxy 20i. Note that the object manager 20j has been described in FIGS. 7A-7C.

The object manager execution unit 210 transfers, e.g., the UI processing module 20b allocated with the object manager 20j and the IF proxy 20i to the information processing terminal 10 via the communication unit 26. The object manager execution unit 210 hands over, e.g., the data processing module 20c allocated with the object manager 20j and the IF proxy 20i to the mobile application execution unit 207.

The mobile application execution unit 207 executes the data processing module 20c allocated with the object manager 20j and the IF proxy 20i. The object manager 20j periodically measures the access performances of the function elements classified, e.g., in the data processing module 20c, and generates the table Tb1 illustrated in FIG. 7B, based on measurement results thereof.

The object manager 20j refers to the table Tb2 illustrated in FIG. 7C, and determines the migration, to the information processing terminal 10, of each function element classified in the data processing module 20c. The migration of the function element is determined by, e.g., comparing the measurement result of the access performance measured per function element with a preset upper limit threshold value.

The object manager 20j extracts, e.g., the function element, determined about the migration, of the data processing module 20c, and hands over the extracted function element to the object manager execution unit 210. The object manager execution unit 210 transmits, e.g., the function element handed over from the object manager 20j to the information processing terminal 10 via the communication unit 26.

Note that the object manager execution unit 210 receives the function element, determined about the migration on the side of the information processing terminal 10 via, e.g., the communication unit 26. The object manager execution unit 210 hands over the received function element to the object manager 20j executed in progress by the mobile application execution unit 207. The object manager 20j adds, e.g., the function element handed over from the object manager execution unit 210 to the data processing module 20c. The function element added to the data processing module 20c is executed by using, e.g., the resources of the server 20.

(Information Processing Terminal)

In the explanatory diagram illustrated in FIG. 8, e.g., the mobile application execution unit 103 executes the UI processing module 20b allocated with the object manager 20j and the IF proxy 20i.

The object manager execution unit 105 receives, e.g., the function element, determined about the migration by the server 20, of the data processing module 20c via the communication unit 16. The object manager execution unit 105 hands over the received function element to the object manager 20j executed in progress by the mobile application execution unit 103. The object manager 20j adds, e.g., the function element handed over from the object manager execution unit 105 to the UI processing module 20b. The function element added to the UI processing module 20b is executed by using, e.g., the resources of the information processing terminal 10. The function element added to the UI processing module 20b is executed in synchronization with, e.g., the Process of the function element, causing the occurrence of the processing request, within the UI processing module 20b.

The object manager 20j allocated to the UI processing module 20b periodically measures, e.g., the access performance of the function elements classified in the UI processing module 20b, and generates the table Tb1 illustrated in FIG. 7B, based on the measurement results. Note that the function elements classified in the UI processing module 20b include the function element added to the UI processing module 20b.

The object manager 20j allocated to the UI processing module 20b refers to, e.g., the table Tb2 illustrated in FIG. 7C, and thus determine the migration of the function element classified in the data processing module 20c to the information processing terminal 10. The migration of the function element is determined by comparing the measurement result of the access performance measured per function element with the preset upper and lower limit threshold values.

The object manager 20j allocated to the UI processing module 20b extracts, e.g., the function element, determined about the migration, of the UI processing module 20b, and hands over the extracted function element to the object manager execution unit 105. The extracted function element is deleted from, e.g., the UI processing module 20b. The object manager execution unit 105 transmits, e.g., the function element handed over from the object manager 20j to the server 20 via the communication unit 16.

[Processing Flow]

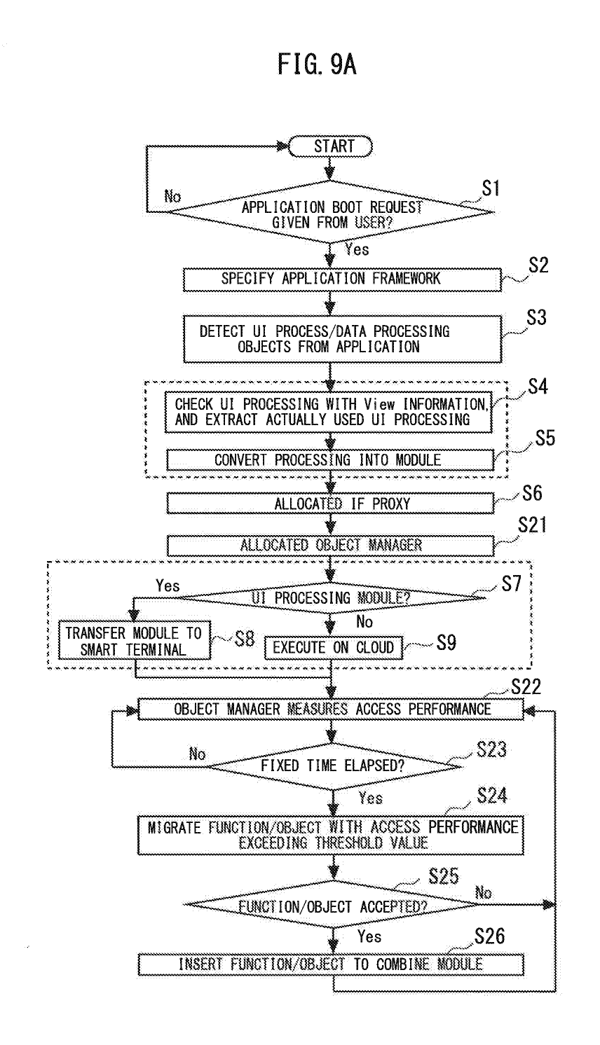

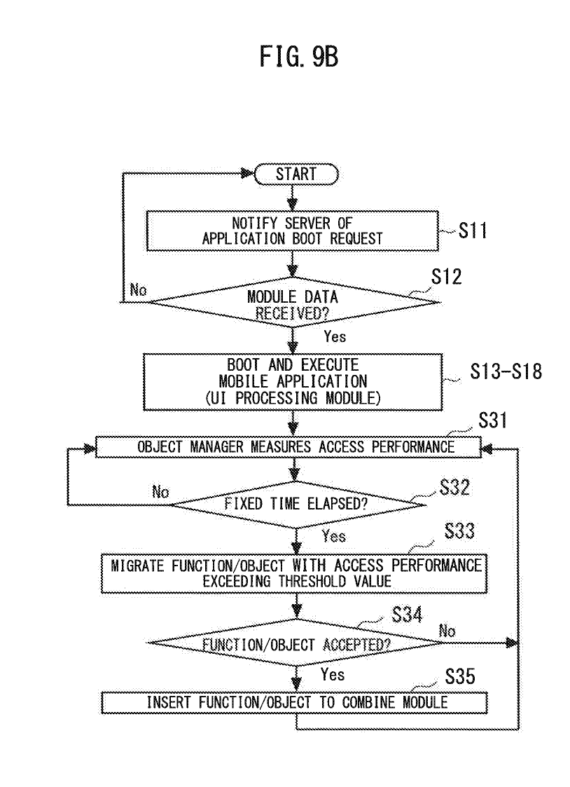

The migration process of the function element between the separated processing modules of the information processing system 1 according to Embodiment 2, will hereinafter be described with reference to flowcharts illustrated in FIGS. 9A and 9B. FIG. 9A illustrates the explanatory flowchart of the migration process of the function element in the server 20. Note that in the explanatory flowchart illustrated in FIG. 9A, processes common to those in the flowchart according to Embodiment 1 illustrated in FIG. 6A are marked with the same numerals and symbols, and their explanations are omitted.

FIG. 9B illustrates the explanatory flowchart of the migration process of the function element in the information processing terminal 10. In the explanatory flowchart illustrated in FIG. 9B, processes common to those in the flowchart according to Embodiment 1 illustrated in FIG. 6B are marked with the same numerals and symbols, and their explanations are omitted.

(Server)

In the flowchart illustrated in FIG. 9A, the server 20 executes the processes in S1-S6 illustrated in FIG. 6A. The server 20 allocates, e.g., the object managers 20j respectively to the UI processing module 20b and the data processing module 20c each allocated with the IF proxy 20i in the process of S6 (S21). The server 20 hands over, to the process in S7, respectively the UI processing module 20b and the data processing module 20c each allocated with the object manager 20j and the IF proxy 20i. The server 20 continuously executes the processes in S7-S9 illustrated in FIG. 6A.

The server 20 executes the data processing module 20c allocated with the object manager 20j and the IF proxy 20i. The object manager 20j periodically measures, e.g., the access performance of each function element classified in the data processing module 20c (S22). Note that the measurement of the access performance has been described in FIGS. 7A and 7B.

The server 20 executing the object manager 20j determines whether a fixed period of time elapses since the measured of the access performance has been started (S23). When the fixed period of time elapses since the measured of the access performance has been started (S23, Yes), the object manager 20j generates the table Tb1 illustrated in FIG. 7B, based on the measurement results. Whereas when the fixed period of time does not elapse since the measured of the access performance has been started (S23, No), the object manager 20j continues measuring the access performance.

In a process of S24, the server 20 executing the object manager 20j compares the measurement result of the access performance measure per function element with the preset upper limit threshold value. The server 20 then causes the function element (function/object), of which the access performance indicates the measurement result equal to or larger than the preset upper limit threshold value on the basis of, e.g., the table Tb2 illustrated in FIG. 7C to migrate to the information processing terminal 10. Note that the description of how the object manager 20j causes the function element to migrate to between the processing modules, has been made in FIGS. 7A-7C and other equivalent drawings.

The server 20 extracts, from the data processing module 20c, the function element, of which the access performance indicates the measurement result equal to or larger than the upper limit threshold value, and transmits the extracted function element to the information processing terminal 10 via the communication unit 26.

In a process of S25, the server 20 determines, e.g., whether the function element transmitted from the information processing terminal 10 is accepted. The server 20, e.g., advances to a process in S26 when accepting the function element transmitted from the information processing terminal 10 (S25, Yes). Whereas when not accepting the function element transmitted from the information processing terminal 10 (S25, No), the server 20 loops back to the process in S22. In the process of S22, the access performances of other function elements exclusive of the function element migrating to the information processing terminal 10 from the data processing module 20c, are continuously periodically measured.

In a process of S26, the server 20 inserts, e.g., the accepted function element into the data processing module 20c, thus combining the module with the function element. After the process in S26, the server 20 loops back to the process in S22. In the process of S22, for instance, the access performances of the function elements of the data processing module 20c including the function element inserted therein in the process of S26, are continuously periodically measured.

(Information Processing Terminal)

In the flowchart illustrated in FIG. 9B, the information processing terminal 10 executes the processes in S11-S18 depicted in FIG. 6B. The information processing terminal 10 executes the UI processing module 20b allocated with the object manager 20j and the IF proxy 20i. In the information processing terminal 10, the object manager 20j allocated to the UI processing module 20b periodically measures the access performances of the function elements classified in, e.g., the data processing module 20c (S31). Note that the measurement of the access performance has been described in FIGS. 7A and 7B.

The information processing terminal 10 executing the object manager 20j determines, e.g., whether the fixed period of time elapses since the measurement of the access performance has been started (S32). The object manager 20j, e.g., when the fixed period of time elapses since the measurement of the access performance has been started (S32, Yes), generates the table Tb1 illustrated in FIG. 7B. Whereas when the fixed period of time does not elapse since the measurement of the access performance has been started (S32, No), the object manager 20j continues measuring the access performances.

In a process of S33, the information processing terminal 10 executing the object manager 20j compares the measurement result of the access performance measured per function element with the preset upper and lower limit threshold values. The information processing terminal 10 then causes the function element (function/object), of which the access performance indicates the measurement result equal to or larger than the preset upper limit threshold value but equal to or smaller than the preset lower limit threshold value, to migrate to the server 20. Note that the description of how the object manager 20j causes the function element to migrate to between the processing modules, has been made in FIGS. 7A-7C and other equivalent drawings.

The information processing terminal 10 extracts and deletes, e.g., from the UI processing module 20b, the function element, of which the access performance indicates the measurement result equal to or larger than the upper limit threshold value but equal to or smaller than the lower limit threshold value. The information processing terminal 10 transmits, e.g., the extracted function element to the server 20 via the communication unit 16.

In a process of S34, the information processing terminal 10 determines whether the function element transmitted from, e.g., the server 20 is accepted. The information processing terminal 10 advances to a process in S35 when the function element transmitted from the server 20 is accepted (S34, Yes). Whereas when the function element transmitted from the server 20 is not accepted, the information processing terminal 10 loops back to the process in S31. In the process of S31, the access performances of other function elements exclusive of the function element migrating to the server 20 from the UI processing module 20b, are continuously periodically measured.

In the process of S35, the information processing terminal 10 inserts, e.g., the accepted function element into the UI processing module 20b, thus combining the function element with the module. After the process in S35, the information processing terminal 10 loops back to the process in S31. In the process of S31, e.g., the access performances of the function elements of the UI processing module 20b inclusive of the function element inserted therein in the process of S35, are periodically continuously measured.

Herein, the processes in S22-S24 executed by the server 20 are one examples of “measuring a process request frequency from the one or more extracted processing codes contained in a processing code group for screen processing”; and “determining a migration of the processing codes, in a program, associated with the processing requests from the processing code group for the screen processing, based on whether the processing request frequency satisfies a predetermined condition, and transmitting the processing codes, associated with the processing request, in the program to the electronic equipment when the predetermined condition is satisfied”. The CPU 21 and other equivalent processors of the server 20 execute the processes in S22-S24 as one example of “to measure a process request frequency from the one or more extracted processing codes contained in a processing code group for screen processing, to determine a migration of the processing codes, in a program, associated with the processing requests from the processing code group for the screen processing, based on whether the processing request frequency satisfies a predetermined condition, and to transmit the processing codes, associated with the processing request, in the program to the electronic equipment when the predetermined condition is satisfied”.

The processes in S31-S35 executed by the information processing terminal 10 are one examples of “receiving the processing codes, in a program, associated with the respective processing requests from the processing code group for the screen processing, the processing code group being transmitted from an information processing apparatus”, and “measuring a processing request frequency from the one or more extracted processing codes contained in a processing code group for screen processing, and transmitting the processing codes, which have been received, in the program to the information processing apparatus, based on whether the processing request frequency satisfies a predetermined condition”. The CPU 11 and other equivalent processors of the information processing terminal 10 execute the processes in S31-S35 as one example of “to receive the processing codes, in a program, associated with the respective processing requests from the processing code group for the screen processing, the processing code group being transmitted from an information processing apparatus, to measure a processing request frequency from the one or more extracted processing codes contained in a processing code group for screen processing, and to transmit the processing codes, which have been received, in the program to the information processing apparatus, based on whether the processing request frequency satisfies a predetermined condition”.

As described above, in the information processing system 1 according to Embodiment 2, the object manager 20j enables the server 20 to periodically measure the access performances of the function elements of the element objects classified as the data processing module 20c. Similarly, the information processing terminal 10 can periodically measure the access performances of the function elements of the element objects classified as UI processing module 20b.

The server 20 can cause each of the function elements classified as the data processing module 20c to migrate to the information processing terminal 10 by making the determination about the upper limit threshold value with respect to the measured access performance of every function element. For example, the function element, satisfying such conditions that the occurrence frequency of the processing request is high and the processing delay time elongates, or a combination of these conditions, in the data processing module 20c, can be made to migrate to the same executing area as that of the function element causing the occurrence of the processing request.

The information processing terminal 10 makes the determination about the upper limit threshold value with respect to the measured access performance of every function element and is thereby enabled to cause the function elements classified as the UI processing module 20b to migrate to the server 20. For instance, the function element, satisfying such conditions that the occurrence frequency of the processing request is high and the processing delay time elongates, or a combination of these conditions, in the UI processing module 20b, can be made to migrate to the same executing area as that of the function element causing the occurrence of the processing request.

The function element exhibiting the high occurrence frequency of the processing request migrates to the same executing area as that of the function element causing the occurrence of the processing request, thereby enabling a reduction in load on the communications for transferring and receiving the data. As a result, the information processing system 1 according to Embodiment 3 can relieve a decline of the operating responsiveness, which is caused by an increase in load on the communications.

The information processing terminal 10 makes the determination about the lower limit threshold value for the measured access performance of every function element, and is thereby enabled to cause the function elements classified as the UI processing module 20b to migrate to the server 20. For example, the function element migrating from the data processing module 20c can further migrate back to the data processing module 20c from which the migration originates. The function element, having a tendency of dealing with the highly confidential information as the data, of the data processing module 20c can be returned back to the server 20 from which the migration originates. As a result, the information processing system 1 according to Embodiment 2 can maintain the security of the information for a long period of time. It is possible to provide the information security taking account of the usage environment of the information processing terminal 10.

### Embodiment 3

The information processing system 1 demonstrated in Embodiment 2 measures the access performances, thereby causing the migration of the function element exhibiting the high occurrence frequency of the processing request between the UI processing module 20b and the data processing module 20c, based on the relative relationship with the upper limit threshold value. Similarly, the migration of post-migrating function element, back to the processing module from which the migration originates, is caused based on the relative relationship with the upper limit threshold value. The upper and lower limit threshold values used for determining the migration of the function element involves using, e.g., fixed values retained beforehand by the object manager 20j.

The information processing system 1 according to a third embodiment (which will hereinafter be termed Embodiment 3) dynamically makes variable the upper and lower limit values used for determining the migration of the function element, corresponding to an operation status of the user operating the information processing terminal 10.

For example, under the mobile environment, the communication environment between the information processing terminal 10 and the server 20 is assumed to vary. Along with the variation of the communication environment, the function element frequently migrates to between the information processing terminal 10 and the server 20, in which case, e.g., the resources of the information processing terminal 10 are allocated to the process of transferring and receiving the data, resulting in the decline of the operating responsiveness.

The information processing system 1 according to Embodiment 3 makes variable the upper and lower limit threshold values of the function elements associated with the processes of the screen display components exhibiting a high operation frequency to facilitate the migrations to the information processing terminal 10. The object manager 20j allocated to the UI processing module 20b contains, e.g., a history acquiring function to acquire an operation history about the screen display components.

The object manager 20j transmits, e.g., the acquired operation history to the server 20. The server 20 makes variable the upper and lower limit threshold values of the function elements associated with the processes of the screen display components exhibiting the high operation frequency to facilitate the migrations to the information processing terminal 10 on the basis of, e.g., the transmitted operation history. The object manager 20j makes variable the upper and lower limit threshold values of the function elements associated with the processes of the screen display components exhibiting the high operation frequency to facilitate the migrations to the server 20 on the basis of, e.g., the acquired operation history.

As a consequence, it is feasible to constrain the migration of the function element between the information processing terminal 10 and the server 20 along with the variation of the communication environment. The operating responsiveness of the information processing terminal 10 can be also restrained from decreasing. Note that the hardware configurations of the information processing terminal 10 and the server 20 according to Embodiment 3 are the same as those according to Embodiment 1.

[Configuration of Processing Blocks]

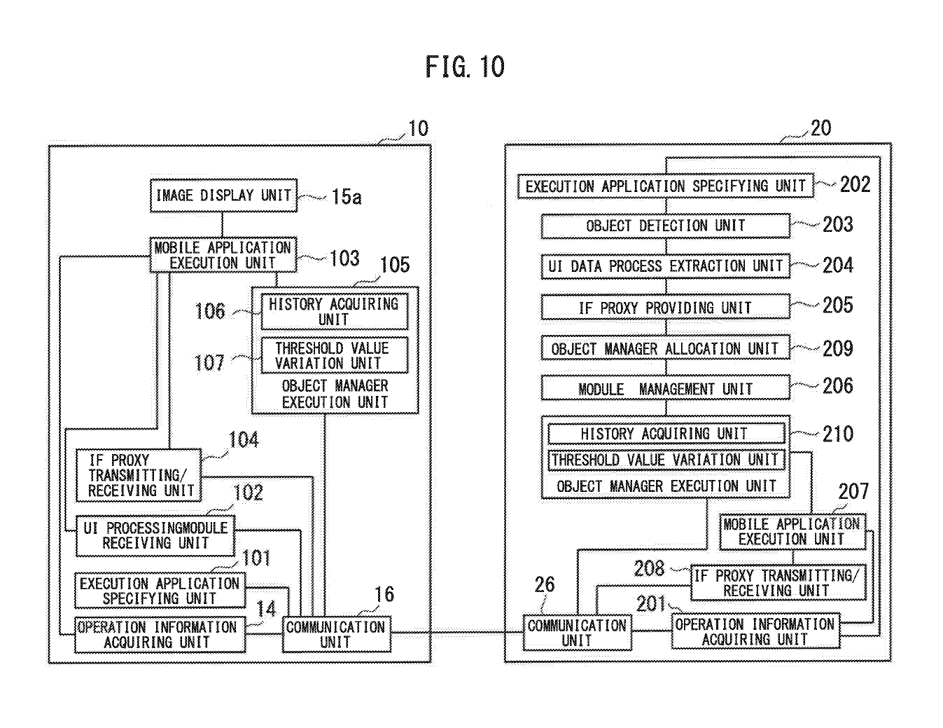

FIG. 10 illustrates an explanatory diagram of the processing blocks in the information processing system 1 according to Embodiment 3. Note that in the explanatory diagram illustrated in FIG. 10, components common to those in the explanatory diagram of the processing blocks according to Embodiment 2 illustrated in FIG. 8 are marked with the same numerals and symbols, and their explanations are omitted.

As illustrated in FIG. 10, in the information processing terminal 10 of the information processing system 1 according to Embodiment 3, the object manager execution unit 105 includes processing functions, i.e., a history acquiring unit 106 and a threshold value variation unit 107 as components added to the configuration of the processing blocks according to Embodiment 2. The object manager execution unit 210 of the server 20 includes processing functions, i.e., a history management unit 211 and a threshold value variation unit 212 as components added to the configuration of the processing blocks according to Embodiment 2.

(Information Processing Terminal)

In the explanatory diagram illustrated in FIG. 10, the history acquiring unit 106 acquires items of operation information instanced by “button A pressed” “button B pressed”, “input to text field” and “scroll” on the display screen of the information processing terminal 10. These items of operation information are acquired via, e.g., an operation information acquiring unit serving as the input unit 14.

The history acquiring unit 106 acquires the function element, causing the occurrence of the processing request due to the operation information described above, of the UI processing module 20b, and the function element, giving a response of the processing result to the processing request having occurred, of the data processing module 20c. The function element causing the occurrence of the processing request and the function element giving the response of the processing result are acquired via, e.g., the mobile application execution unit 103.

The history acquiring unit 106 temporarily stores the acquired function element causing the occurrence of the processing request and the acquired function element giving the response of the processing result in a predetermined area of the main storage unit 13 by being associated with the operation information. For example, the storage of the information described above is repeated whenever the operation information on the display screen occurs, whereby the items of operation information are accumulated as a history (operation history information) in the main storage unit 13.

The history acquiring unit 106 acquires the operation history information accumulated in the main storage unit 13 at timing when the object manager 20j periodically measures the access performance. For example, the items of operation information of most recent 60 operations conducted on the display screen are available as the operation history information to be acquired. Note that the operation history information to be acquired may also be acquired in a unit period, e.g., on the minute basis and other equivalent bases. The operation history information accumulated since the measurement of the access performance has been performed last time, may also be acquired.

The history acquiring unit 106 transmits the acquired operation history information to, e.g., the server 20. The operation history information is transmitted via the communication unit 16. The history acquiring unit 106 hands over the acquired operation history information to the threshold value variation unit 107.

The threshold value variation unit 107 varies the upper and lower limit threshold values for determining the migration of the function element, based on the operation history information handed over from the history acquiring unit 106. The threshold value variation unit 107 varies the upper and lower limit threshold values to make it difficult that the function element executed by the information processing terminal 10 migrates to the server 20.

The threshold value variation unit 107 specifies the items of operation information instanced by the operation components, i.e., “button A pressed”, “button B pressed” displayed on the display screen from within the acquired operation history information. The threshold value variation unit 107 calculates a rate at which the specified operation information occupies the acquired operation history information per operation component displayed on the display screen.

For instance, a numerical quantity of the acquired operation history information is set to, e.g., “100”. When the numerical quantity of the operation information against the operation component “button A pressed” contained in the operation history information is “20”, the rate of the operation information against the operation component “button A pressed” becomes “20%”. Similarly, when the numerical quantity of the operation information against the operation component “button B pressed” is “40”, the rate of the operation information against the operation component “button B pressed” becomes “40%”.

The threshold value variation unit 107 determines that the operation frequency about the operation component concerned is high when the rate against the whole items of operation history information is equal to or larger than “30%”. In the instance described above, the operation frequency about, e.g., the operation component “button B pressed” is determined to be high.

The threshold value variation unit 107 specifies the function element associated with the operation information from within the operation history information of the operation component, of which the operation frequency is determined high. The threshold value variation unit 107 sets high the respective upper and lower limit threshold values for determining the migration of the specified function element. The upper and lower limit threshold values are set high, whereby the migration for returning the post-migrating function element back to the migration originating side can be restrained.

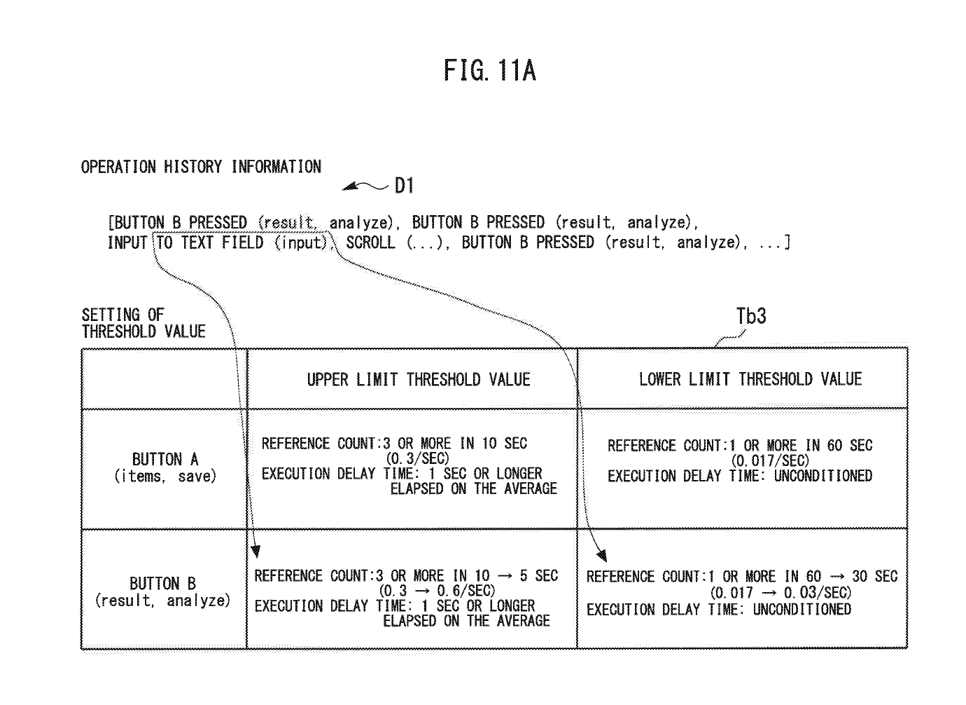

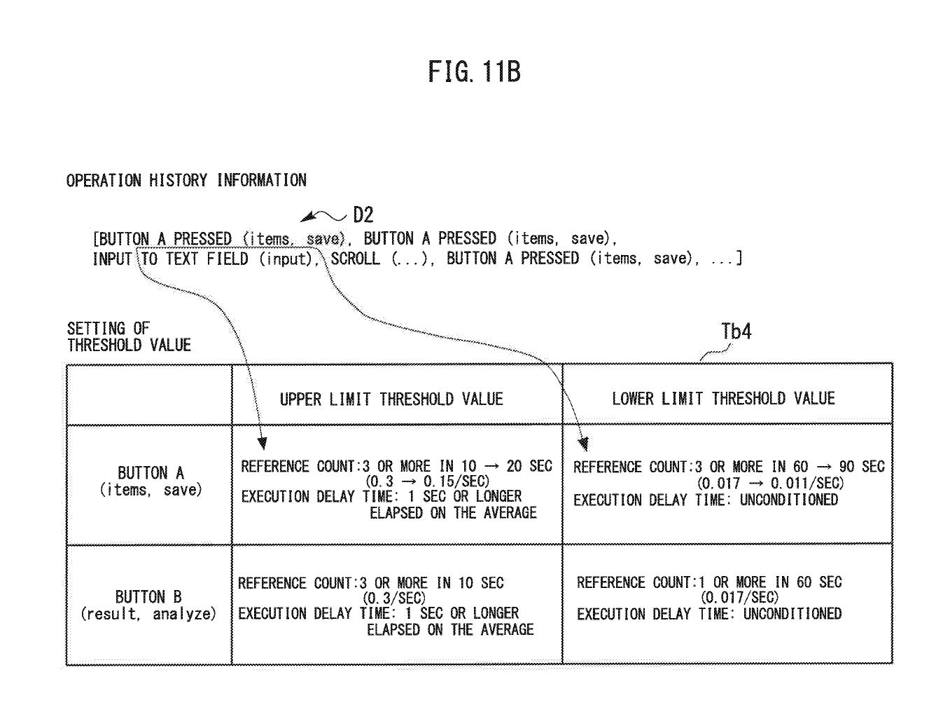

FIG. 11A illustrates a variation example of setting high the upper and lower limit threshold values for determining the migration. In FIG. 11A, operation history information D1 represents the operation history information acquired by the threshold value variation unit 107. Further, Tb3 represents a table indicating setting statuses of the post-varying upper and lower limit threshold values.

FIG. 11A illustrates a status in which the rate, at which of the operation component “button B pressed” occupies the operation history information D1, is equal to or larger than “30% with the operation frequency determined to be high. A pre-varying upper limit threshold value is such that the “data reference count” is equal to or larger than “3 in 10 sec”, and the “execution delay time” is “1 sec or longer elapsed on the average”. A pre-varying lower limit threshold value is such that the “data reference count” is “1 or more in 60 sec”, and the “execution delay time” is “unconditioned”.

The operation component “button B pressed” is contained in “button B pressed (result, analyze), button B pressed (result, analyze), input to text field (input)”, scroll ( . . . ), button B pressed (result, analyze), . . . ” of the operation history information D1 in FIG. 11A. Elements “(result, analyze)” subsequent to the operation component “button B pressed” represent the function element “result” causing the occurrence of the processing request and the function element “analyze” giving the response of the result to the processing request.

In the example of FIG. 11A, as indicated in an intersecting position between the column “button B (result, analyze)” in the lengthwise direction of the table Tb3 and the column of “upper limit threshold value” in the crosswise direction, the “data reference count” varies from “3 or above in 10 sec” to “3 or above in 5 sec”. There is no variation in upper limit threshold value being such that the “execution delay time” is “1 sec or longer elapsed on the average”.

Similarly, as indicated in an intersecting position between the column “button B (result, analyze)” in the lengthwise direction of the table Tb3 and the column of “lower limit threshold value” in the crosswise direction, the “data reference count” varies from “1 or above in 60 sec” to “1 or above in 30 sec”.

Note that the variations of the upper and lower limit threshold values may contain the variation of the “execution delay time”. The “execution delay time” may also be varied. The upper and lower limit threshold values may be set corresponding to the display components displayed on the display screen, the function giving the response of the result to the processing request that occurs, and other equivalent elements.

(Server)

In the explanatory diagram illustrated in FIG. 10, e.g., the history management unit 211 receives via the communication unit 26 the operation history information transmitted from the information processing terminal 10. The received operation history information is temporarily stored, e.g., in a predetermined area of the main storage unit 13. The history management unit 211 hands over the received operation history information to the threshold value variation unit 212.

Similarly to the threshold value variation unit 107, the threshold value variation unit 212 varies, e.g., the upper lower limit threshold values for determining the migration of the function element, based on the operation history information handed over from the history management unit 211. However, the threshold value variation unit 212 varies, e.g., the upper and lower limit threshold values to facilitate the migration of the function element executed by the server 20 to the information processing terminal 10.

FIG. 11B illustrates a variation example of setting low the upper and lower limit threshold values for determining the migration. In FIG. 11B, operation history information D2 represents the operation history information acquired by the threshold value variation unit 212. Further, Tb4 represents a table indicating setting statuses of the post-varying upper and lower limit threshold values. A pre-varying upper limit threshold value is such that the “data reference count” is equal to or larger than “3 in 10 sec”, and the “execution delay time” is “1 sec or longer elapsed on the average”. A pre-varying lower limit threshold value is such that the “data reference count” is “1 or more in 60 sec”, and the “execution delay time” is “unconditioned”.

The operation component “button A pressed” is contained in “button A pressed (items, save), button A pressed (items, save), input to text field (input)”, scroll ( . . . ), button A pressed (items, save), . . . ” of the operation history information D2 in FIG. 11B. Elements “(items, save)” subsequent to the operation component “button B pressed” represent the function element “items” causing the occurrence of the processing request and the function element “save” giving the response of the result to the processing request.

The threshold value variation unit 212 calculates a rate at which the operation component “button A pressed” occupies, e.g., the operation history information D2. In FIG. 11B, a rate of the operation component “button A pressed” against a total number of items of operation information is determined to be equal to or larger than “30%”. The threshold value variation unit 212 therefore determines that the operation frequency of the operation component “button A pressed” is high.

The threshold value variation unit 212 specifies the function element associated with the operation information from within, e.g., the operation history information of the operation component of which the operation frequency is determined to be high. Specified in FIG. 11B are the function elements “items” and “save” associated with the operation component “button A pressed”.

The threshold value variation unit 212 sets low the respective upper and lower limit threshold values for determining the migration of the specified function element. The migration of the function element giving the response to the processing request can be promptly done by, e.g., setting low the upper and lower limit threshold values.

In the example of FIG. 11A, as indicated in an intersecting position between the column “button A (items, save)” in the lengthwise direction of the table Tb4 and the column of “upper limit threshold value” in the crosswise direction, the “data reference count” varies from “3 or above in 10 sec” to “3 or above in 20 sec”. There is no variation in upper limit threshold value being such that the “execution delay time” is “1 sec or longer elapsed on the average”.

Similarly, as indicated in an intersecting position between the column “button A (items, save)” in the lengthwise direction of the table Tb4 and the column of “lower limit threshold value” in the crosswise direction, the “data reference count” varies from “1 or above in 60 sec” to “1 or above in 90 sec”.

The threshold value variation unit 212 can vary, e.g., the “data reference counts” of the upper and lower limit threshold values. The “execution delay time” may also be varied. Alternatively, the upper and lower limit threshold values can be varied by combining the “data reference count” and the “execution delay time”. The variations of the upper and lower limit threshold values may be set corresponding to, e.g., the display component displayed on the display screen, the function giving the response of the result to the processing request that occurs, and other equivalent elements.

[Processing Flow]

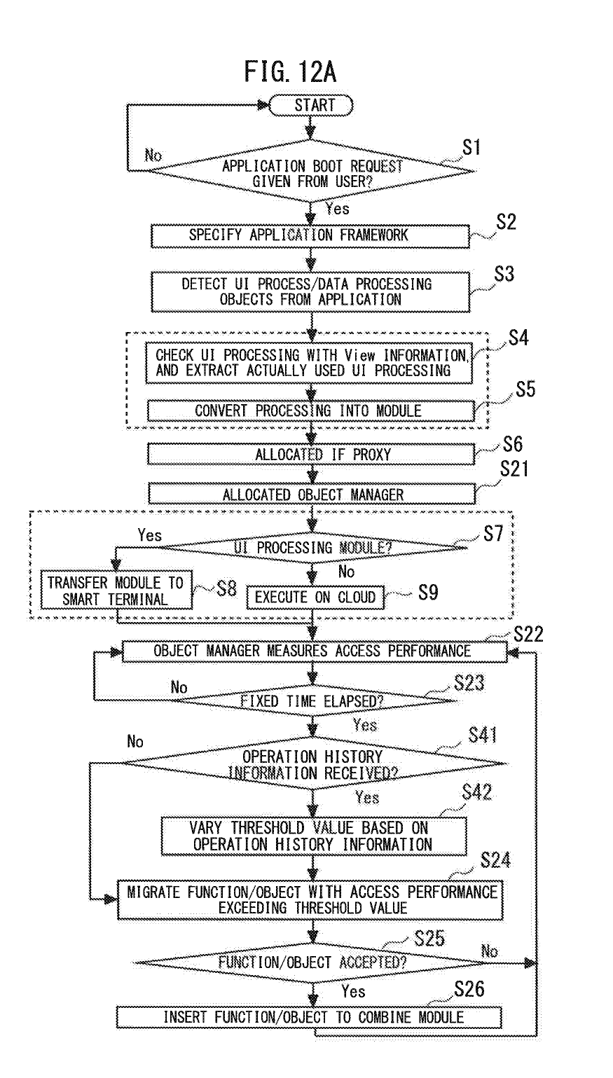

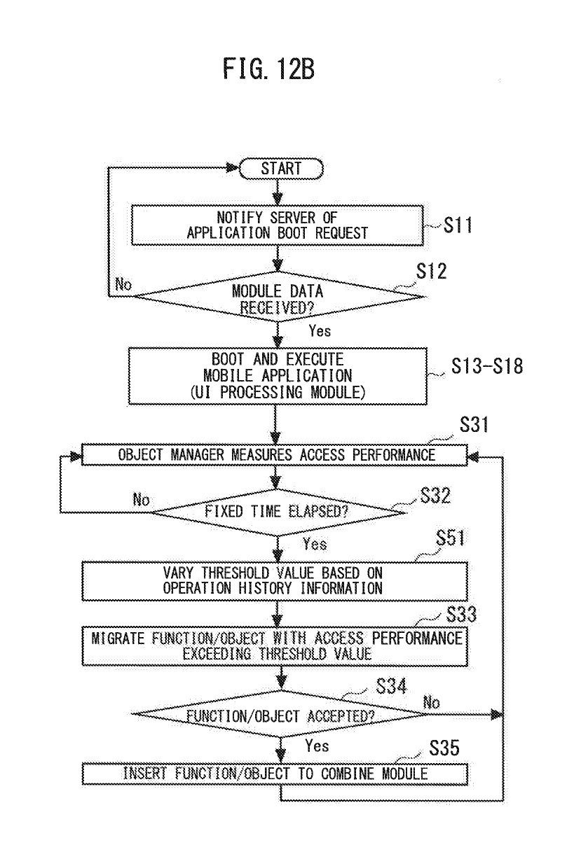

Processes of varying the upper and lower limit threshold values for determining the migration in the information processing system 1 according to Embodiment 3 will hereinafter be described with reference to flowcharts illustrated in FIGS. 12A and 12B. FIG. 12A illustrates the explanatory flowchart of the processes of varying the upper and lower limit threshold values for determining the migration in the server 20. Note that in the explanatory flowchart illustrated in FIG. 12A, the processes common to the flowchart according to Embodiment 2 depicted in FIG. 9A are marked with the same numerals and symbols, and their explanations are omitted.

FIG. 12B illustrates the explanatory flowchart of the processes of varying the upper and lower limit threshold values for determining the migration in the information processing terminal 10. In the explanatory flowchart illustrated in FIG. 12B, the processes common to the flowchart according to Embodiment 2 depicted in FIG. 9B are marked with the same numerals and symbols, and their explanations are omitted.

(Server)

In the flowchart illustrated in FIG. 12A, the server 20 executes the processes S1-S9 and S21-S23 depicted in FIG. 9A. The server 20 determines whether the operation history information transmitted from the information processing terminal 10 is received (S41). The server 20 advances to a process in S42 when receiving the operation history information transmitted from the information processing terminal 10 (S41, Yes). Whereas when not receiving the operation history information transmitted from the information processing terminal 10 (S41, No), the server 20 diverts to the process in S24 by skipping over a process in S42.

In the process of S42, the server 20 varies the upper and lower limit threshold values for determining the migration of the function element classified in the data processing module 20c, based on, e.g., the received operation history information. The variations of the upper and lower limit threshold values based on the operation history information have been described in FIGS. 10, 11A and 11B.

The server 20 specifies the function elements (e.g., “items”, “save”) associated with the operation component (e.g., “button B”) having the high operation frequency from within, e.g., the received operation history information. The server 20 specifies the function element (e.g., “save”) in the data processing module 20c, this function element giving the response to the function element (e.g., “items”) causing the occurrence of the processing request.

The server 20 varies the upper and lower limit threshold values for determining the migration of the specified function element (e.g., “save”) to facilitate the migration to, e.g., the information processing terminal 10. The upper and lower limit threshold values are varied per function element. The server 20 sets to decrease, e.g., the preset upper and lower limit threshold values for determining the migration.

The server 20 continuously executes the processes in S24-S26 after executing the processes in S41-S42. For example, in the process of S24, when there exists the history information of the operation component exhibiting the high operation frequency, the function element migrates to between the processing modules on the basis of the upper and lower limit threshold values with the variation setting being conducted. In the process of S24, whereas when there does not exist the history information of the operation component exhibiting the high operation frequency, the function element migrates to between the processing modules on the basis of the preset upper and lower limit threshold values.

(Information Processing Terminal)

In the flowchart illustrated in FIG. 12B, the information processing terminal 10 executes the processes in S11-S18 and S31-S32 depicted in FIG. 9B. In the process of S51, the information processing terminal 10 varies the upper and lower limit threshold values for determining the migration of the function element classified in the UI processing module 20b on the basis of, e.g., operation history information. Note that the variations of the upper and lower limit threshold values based on the operation history information have been described in FIGS. 10, 11A and 11B.

The information processing terminal 10 varies the upper and lower limit threshold values for determining the migration of the function element (e.g., “analyze”) associated with the operation component (e.g., “button A”) exhibiting the high operation frequency so as to make it difficult to migrate to the server 20. For instance, the information processing terminal 10 sets to increase the preset upper and lower limit threshold values for determining the migration. Note that the upper and lower limit threshold values are varied per function element.

The information processing terminal 10 continuously executes the processes in S33-S35 after executing the process in S51. For example, when the function element “analyze” associated with operation component (e.g., “button A”) migrates from the server 20, the migration of the function element “analyze” to the server 20 is restrained during a continuation of the status of exhibiting the high operation frequency of the operation component.

Herein, the processes in S41-S42 executed by the server 20 are one examples of “determining the predetermined condition from a relationship between a processing request frequency and a predetermined threshold value”, and “varying the predetermined threshold value to a substantially high setting value when an operation frequency of a screen display component on a screen pertaining to a processing code group for screen processing satisfies a predetermined condition”. The CPU 21 and other equivalent processors of the server 20 execute the processes in S41-S42 as one example of “determining the predetermined condition from a relationship between a processing request frequency and a predetermined threshold value, and varying the predetermined threshold value to a substantially high setting value when an operation frequency of a screen display component on a screen pertaining to a processing code group for screen processing satisfies a predetermined condition”.

The processes in S31-S35 executed by the information processing terminal 10 are one examples of “receiving the processing codes, in a program, associated with the respective processing requests from the processing code group for the screen processing, the processing code group being transmitted from an information processing apparatus, measuring a processing request frequency from the one or more extracted processing codes contained in a processing code group for screen processing, and transmitting the processing codes, which have been received, in the program to the information processing apparatus, based on whether the processing request frequency satisfies a predetermined condition”. The CPU 11 and other equivalent processors of the information processing terminal 10 execute the processes in S31-S35 as one example of “to receive the processing codes, in the program, associated with the respective processing requests from the processing code group for the screen processing, the processing code group being transmitted from an information processing apparatus, to measure a processing request frequency from the one or more extracted processing codes contained in a processing code group for screen processing, and to transmit the processing codes, which have been received, in the program to the information processing apparatus, based on whether the processing request frequency satisfies a predetermined condition”.

### Embodiment 4

It is as already described that the highly confidential information instanced by the individual information pertaining to utilizing the services is used for the various categories of data processing in the mobile application 20a installed in the information processing terminal 10. The information processing system 1 according to a fourth embodiment (which will hereinafter be termed Embodiment 4) provides, e.g., definitions of security levels for restricting validity of the migration of each of the function elements described in the source codes 20g of the mobile application 20a.

The information processing system 1 according to Embodiment 4 can protect each of the function elements classified as the respective processing modules from criticality instanced by the leakage of information by providing the definitions of the security levels. The information processing system 1 according to Embodiment 4 can protect the highly confidential information pertaining to utilizing the services on a per element basis of the function elements described in the source codes 20g. The information processing system 1 according to Embodiment 4 is compatible with the security and the operating responsiveness on the per element basis of the function elements defined in the source codes 20g of the mobile application 20a.

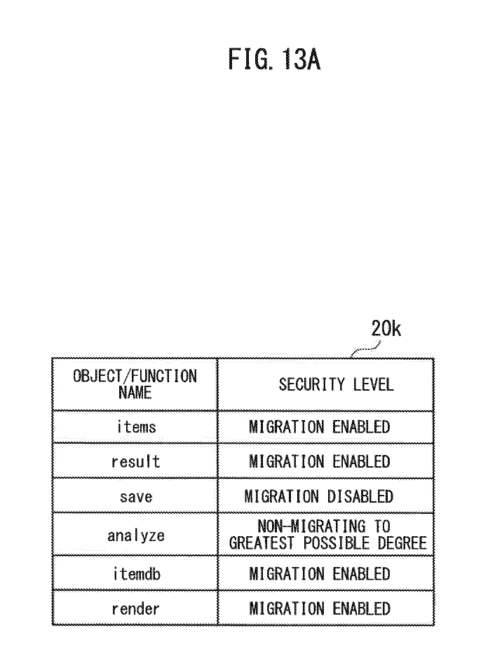

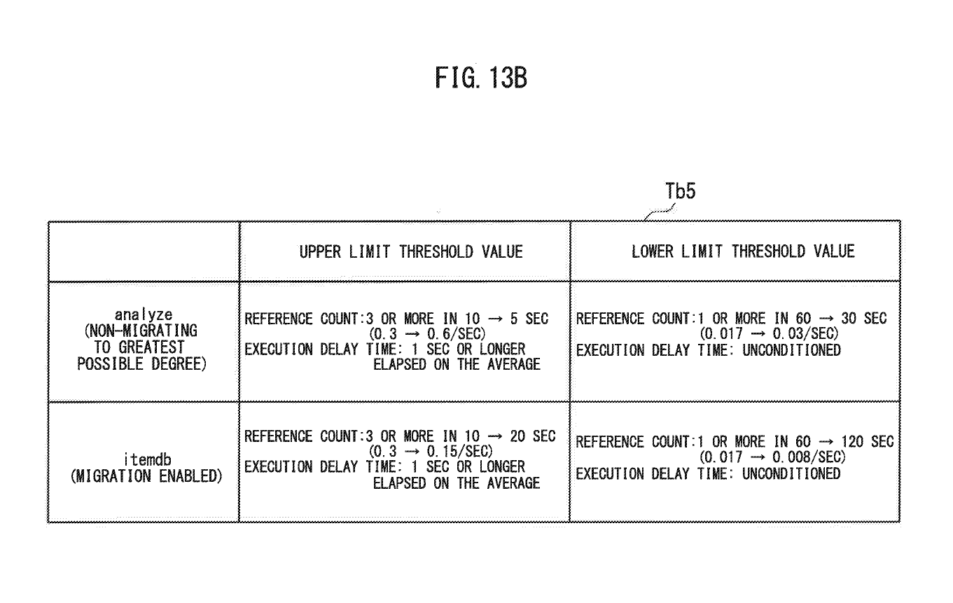

FIG. 13A illustrates an example of the definitions of the security levels. A security level definition table 20k illustrated in FIG. 13A is one example of setting the security levels for the function elements at 3 stages. It does not, however, mean that a number of stages of setting the security levels is limited to “3”. The number of stages of the security levels can be set by taking account of service contents, service modes and environments of utilizing the services each using the mobile application 20a. Note that the security levels are set by providers who provide the services each using the mobile application 20a.

The security level definition table 20k illustrated in FIG. 13A contains records each provided per function element (object/function name). The security levels are set in the respective records. The security levels at 3 stages instanced by “migration disabled”, “non-migrating to greatest possible degree” and “migration enabled” are set in the security level definition table 20k illustrated therein. For example, the security level “migration enabled” is set in the function elements “items”, “result”, “itemdb” and “render”. The security level “non-migrating to greatest possible degree” is set in the function element “analyze”. The security level “migration disabled” is set in the function element “save”.

The security level “migration enabled” is a security level enabling the migration of the function element to between the UI processing module 20b and the data processing module 20c described in, e.g., Embodiment 2 and other equivalent embodiments.

Note that the migration originating side may vary the upper and lower limit threshold values for determining the migrations of the function elements with “migration enabled” being set so as to facilitate the migrations. The migration destination side may also vary the upper and lower limit threshold values for determining the migrations of the function elements with “migration enabled” being set so as to make it difficult that the post-migrating function elements migrate back to the migration originating side. When the migration destination side is the processing module of the information processing terminal 10, e.g., improvement of the operating responsiveness can be expected.

The security level “migration disabled” is, e.g., a security level at which the function element does not migrate to between the UI processing module 20b and the data processing module 20c as discussed in Embodiment 2 and other equivalent embodiments.

Note that the function elements set at the security level “migration disabled” are, even when classified as the UI processing module 20b in the process of separating, e.g., the mobile application 20a, extracted from the UI processing module 20b after being classified, and are integrated into the data processing module 20c. The function elements with “migration disabled”, which are classified into the UI processing module 20b, are deleted and then combined with the data processing module 20c.

The security level “non-migrating to greatest possible degree” is a security level between “migration enabled” and “migration disabled”. Varied, however, are the upper and lower limit threshold values for determining the migration of the function element with “non-migrating to greatest possible degree” being set.

For example, the function elements with “non-migrating to greatest possible degree” being set are to be contained in the data processing module 20c. The server 20 executing the data processing module 20c varies the upper and lower limit threshold values for determining the migration of the function element so as to increase the setting values thereof. The function element with the upper and lower limit threshold values being set high becomes hard to migrate.

The migration destination side (e.g., the information processing terminal 10) of the function element, of which the security level is set to “non-migrating to greatest possible degree”, sets low the upper and lower limit threshold values for determining the migration in order to facilitate the migration back to the migration originating side. The function element with “non-migrating to greatest possible degree” being set can return back to the server 20 (the migration originating side) in a short period of time even when migrating to the information processing terminal 10 (the migration destination side).

FIG. 13B illustrates a table Tb5 indicating an example of setting the upper and lower limit threshold values on the basis of the security level definition table 20k. In the table Tb5, the function element “analyze” is set at the security level “non-migrating to greatest possible degree”, and the function element “itemdb” is set at the security level “migration enabled”. Note that the table Tb5 illustrated in FIG. 13B is, e.g., a variation example in the server 20 including the data processing module 20c as the migration originating module retaining the respective function elements.

Herein, a pre-varying upper limit threshold value of each function element is such that the “data reference count” is equal to or larger than “3 in 10 sec”, and the “execution delay time” is “1 sec or longer elapsed on the average”. Similarly, a pre-varying lower limit threshold value of each function element is such that the “data reference count” is “1 or more in 60 sec”, and the “execution delay time” is “unconditioned”.

As illustrated in FIG. 13B, in the function element “analyze” with “non-migrating to greatest possible degree” being set, the upper limit threshold value is such that the “data reference count” is varied to “3 or more in 5 sec” from “3 or more in 10 sec”. There is no variation in upper limit threshold value being such that the “execution delay time” is “1 sec or longer elapsed on the average”. Similarly, the lower limit threshold value is such that the “data reference count” is varied to “1 or more in 30 sec” from “1 or more in 60 sec”. It is recognized that the relatively strict upper and lower limit threshold values are set as compared with the pre-varying set values.

In the function element “itemdb” with “migration enabled” being set, the upper limit threshold value is such that the “data reference count” is varied to “3 or more in 20 sec” from “3 or more in 10 sec”. There is no variation in upper limit threshold value being such that the “execution delay time” is “1 sec or longer elapsed on the average”. Similarly, the lower limit threshold value is such that the “data reference count” is varied to “1 or more in 120 sec” from “1 or more in 60 sec”. It is recognized that the relatively loose upper and lower limit threshold values are set as compared with the pre-varying set values.

In the function element “analyze” with “non-migrating to greatest possible degree” being set, it is understood that the upper and lower limit threshold values are varied to make the migration difficult. In the function element “itemdb” with “migration enabled” being set, it is recognized that the upper and lower limit threshold values are varied to facilitate the migration.

[Configuration of Processing Blocks]

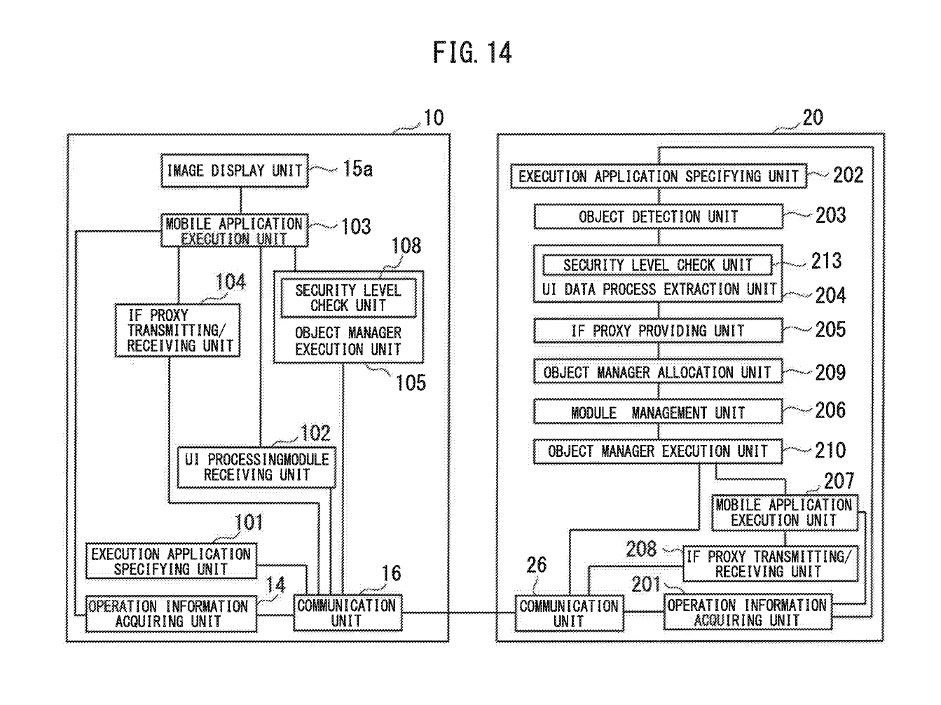

FIG. 14 illustrates an explanatory diagram of processing blocks of the information processing system 1 according to Embodiment 4. Note that in the explanatory diagram illustrated in FIG. 14, the components common to the explanatory diagram of the processing blocks in Embodiment 2 illustrated in FIG. 8 are marked with the same numerals and symbols, and their explanations are omitted.

As illustrated in FIG. 14, in the information processing terminal 10 of the information processing system 1 according to Embodiment 4, the object manager execution unit 105 includes a processing function, i.e., a security level check unit 108 added to the configuration of the processing blocks according to Embodiment 2. In the server 20, the UI data process extraction unit 204 includes a processing function, i.e., a security level check unit 213 added to the configuration of the processing blocks according to Embodiment 2.

(Server)

The UI data process extraction unit 204 checks the low-order processing objects (elements) instanced by the functions and the variables classified in the tables m3, m4, which are handed over from the object detection unit 203, against the HTML file 20h. As a result of checking, there are extracted the elements instanced by the functions and the variables in the tables m3, m4, which are described in the HTML file 20h.

The security level check unit 213 extracts, e.g., the function elements with “migration disabled” being set from the function elements extracted as the elements described in the HTML file 20h by referring to the security level definition table 20k. The security level check unit 213 deletes, e.g., the extracted function elements from the element group to generate the UI processing module 20b, and adds the extracted function elements to the element group to generate the data processing module 20c. The function elements extracted by the security level check unit 213 are integrated with the data processing module 20c.

The security level check unit 213 varies, e.g., the upper and lower limit threshold values for determining the migrations of the function elements with “non-migrating to greatest possible degree” and “migration enabled” being set, based on the security level check unit 213. The variations of the upper and lower limit threshold values on the basis of the security level definition table 20k have been described in FIGS. 13A and 13B. The varied upper and lower limit threshold values per function element are temporarily stored, e.g., in the predetermined area of the main storage unit 23.

Note that the object manager 20j allocated to the data processing module 20c compares, e.g., the measurement result of the access performance measured per function element with the post-varying upper and lower limit threshold values, thereby determining the migration of the function element.

(Information Processing Terminal)

In the explanatory diagram of FIG. 14, the security level check unit 108 varies, e.g., the upper and lower limit threshold values for determining the migrations of the function elements with “non-migrating to greatest possible degree” and “migration enabled” being set, based on the security level definition table 20k. The variations of the upper and lower limit threshold values on the basis of the security level definition table 20k have been described in FIGS. 13A and 13B. The varied upper and lower limit threshold values per function element are temporarily stored, e.g., in the predetermined area of the main storage unit 13.

Note that the object manager 20j allocated to the UI processing module 20b compares, e.g., the measurement result of the access performance measured per function element with the post-varying upper and lower limit threshold values, thereby determining the migration of the function element.

[Processing Flow]

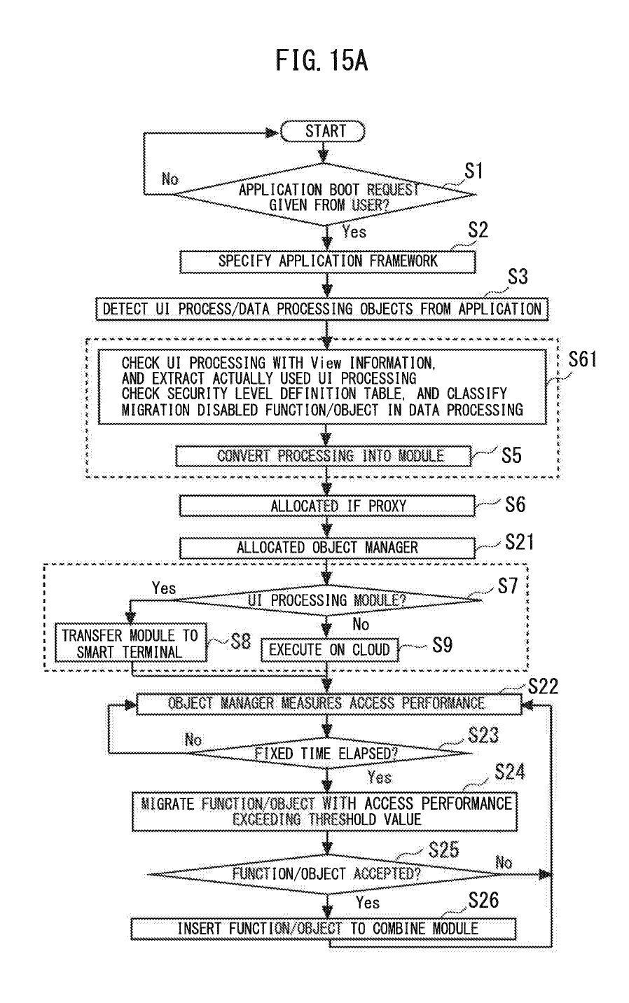

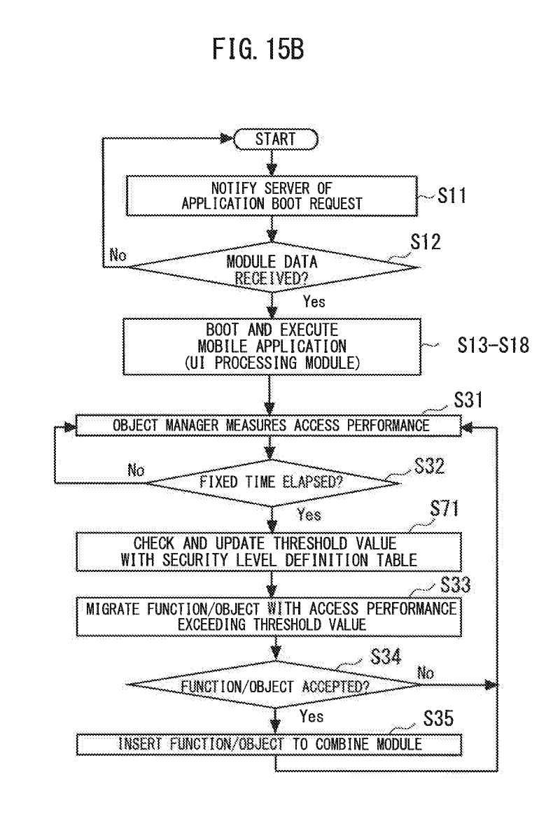

Processes of varying the upper and lower limit threshold values on the basis of the security levels in the information processing system 1 according to Embodiment 4 will hereinafter be described with reference to flowcharts illustrated in FIGS. 15A and 15B. FIG. 15A illustrates the explanatory flowchart of the processes of varying the upper and lower limit threshold values on the basis of the security levels in the server 20. Note that in the explanatory flowchart illustrated in FIG. 15A, the processes common to the flowchart according to Embodiment 2 depicted in FIG. 9A are marked with the same numerals and symbols, and their explanations are omitted.

FIG. 15B illustrates the explanatory flowchart of the processes of varying the upper and lower limit threshold values on the basis of the security levels in the information processing terminal 10. In the explanatory flowchart illustrated in FIG. 15B, the processes common to the flowchart according to Embodiment 2 depicted in FIG. 9B are marked with the same numerals and symbols, and their explanations are omitted.

(Server)

In the flowchart illustrated in FIG. 15A, the server 20 executes the processes S1-S3 depicted in FIG. 9A. In a process of S61, the server 20 checks, e.g., View information against the element objects instanced by the functions and the variables classified in the tables m3 and m4, and extracts the element objects of the UI processing, which are utilized as View information. Herein, “View information” is a program to describe the screen displayed on the LCD 15a and other equivalent displays of the information processing terminal 10, and is described by the Markup language instanced by HTML, XML and XAML.

The server 20 checks, e.g., the character strings described in the HTML file 20h of the mobile application 20a against the names of the element objects classified within the tables m3 and m4. The server 20 extracts, e.g., the element objects already described in the HTML file 20h as the element objects to be used for the UI processing. Similarly, the server 20 extracts, e.g., the element objects not described in the HTML file 20h as the element objects to be used for the data processing. Note that the server 20 may also extract other element objects excluding the element objects to be used for the UI processing as the element objects to be used for the data processing.

The server 20 extracts, e.g., the function elements with “migration disabled” being set from within the functions and the variables extracted as the element objects used for the UI processing by referring to the security level definition table 20k. The server 20 deletes the extracted function elements from, e.g., the element object group used for the UI processing, and adds the extracted function elements to the element object group used for the data processing.

The server 20 varies, e.g., the upper and lower limit threshold values for determining the migrations of the function elements with “non-migrating to greatest possible degree” and “migration enabled” being set, based on the security level definition table 20k. The varied upper and lower limit threshold values per function element are temporarily stored, e.g., in the predetermined area of the main storage unit 23.

The server 20 continuously executes the processes in S5-S9 and S21-S26 after executing the process in S61. For example, in the process of S5, the server 20 generates the UI processing module 20b by integrating the element object group obtained by deleting the function elements with “migration disabled” being set in the security level definition table 20k from the element object group used for the UI processing. Similarly, the server 20 generates the data processing module 20c by integrating the element object group, used for the data processing, to which to add the function elements with “migration disabled” being set in the security level definition table 20k. In the process of S24, the function elements migrate to between the processing modules on the basis of the upper and lower limit threshold values per function element, which are varied based on the security level definition table 20k.

(Information Processing Terminal)

In the flowchart illustrated in FIG. 12B, the information processing terminal 10 executes the processes in S11-S18 and S31-S32 depicted in FIG. 9B. In a process of S71, the information processing terminal 10 varies the upper and lower limit threshold values for determining the migration of every function element classified into the UI processing module 20b on the basis of, e.g., the security level definition table 20k. Note that the variations of the upper and lower limit threshold values on the basis of the security level definition table 20k have been described in FIGS. 13A and 13B.

The security level check unit 108 varies the upper and lower limit threshold values for determining the migrations of the function elements with “non-migrating to greatest possible degree” and “migration enabled” being set on the per-element basis by referring to the, e.g., security level definition table 20k. The varied upper and lower limit threshold values per function element are temporarily stored, e.g., in the predetermined area of the main storage unit 13.

The information processing terminal 10 continuously executes the processes in S33-S35 after executing the process in S71. For example, the function elements with “migration enabled” being set, which have migrated to the information processing terminal 10, are restrained from migrating back to the server 20 from which the migration originates. The function elements with “non-migrating to greatest possible degree” being set, which have migrated to the information processing terminal 10, are prompted to migrate back to the server 20 from which the migration originates in a short period of time.

Herein, the process in S61 executed by the server 20 is one example of “determining a predetermined condition from a relationship between the processing request frequency and a predetermined threshold value, containing security level information set per processing code, in the program, associated with the processing requests from the processing code group for the screen processing, and varying a setting value of the predetermined threshold value relatively based on the security level information”. The CPU 21 and other equivalent processors of the server 20 execute the process in S61 as one example of “to determine a predetermined condition from a relationship between the processing request frequency and a predetermined threshold value, to contain security level information set per processing code, in a program, associated with the processing requests from the processing code group for the screen processing, and to vary a setting value of the predetermined threshold value relatively based on the security level information”.

The process in S71 executed by the information processing terminal 10 is one example of “determining a predetermined condition from a relationship between a processing request frequency and the predetermined threshold value, containing security level information set per processing code, in the program, associated with the processing requests from the processing code group for the screen processing, and varying a setting value of a predetermined threshold value relatively based on the security level information”. The process in S71 is executed as one example of “to determine a predetermined condition from a relationship between the processing request frequency and a predetermined threshold value, to contain security level information set per processing code, in the program, associated with the processing requests from the processing code group for the screen processing, and to vary a setting value of the predetermined threshold value relatively based on the security level information”.

According to the information processing system described above, it is feasible to provide the technology compatible with both ensuring the security of the information of the program pertaining to utilizing the services and ensuring the operating responsiveness.

<<Non-Transitory Computer Readable Recording Medium>>

A program making a computer, other machines and apparatuses (which will hereinafter be referred to as the computer and other equivalent apparatuses) attain any one of the functions, can be recorded on a non-transitory recording medium readable by the computer and other equivalent apparatuses. The computer and other equivalent apparatuses are made to read and run the program on this non-transitory recording medium, whereby the function thereof can be provided.

Herein, the non-transitory recording medium readable by the computer and other equivalent apparatuses connotes a non-transitory recording medium capable of accumulating information instanced by data, programs and other equivalent information electrically, magnetically, optically, mechanically or by chemical action, which can be read from the computer and other equivalent apparatuses. Among these non-transitory recording mediums, the mediums removable from the computer and other equivalent apparatuses are exemplified by a flexible disc, a magneto-optic disc, a CD-ROM, a CD-R/W, a DVD, a Blu-ray disc, a DAT, an 8 mm tape, and a memory card like a flash memory. A hard disc, a ROM and other equivalent recording mediums are given as the non-transitory recording mediums fixed within the computer and other equivalent apparatuses.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a processor configured to extract one or more processing codes describing a screen of the program by analyzing processing codes in a program;
to generate a processing code group for screen processing by combining one or more extracted processing codes in a manner of being executable by an electronic equipment;
to transmit the processing code group for the screen processing to the electronic equipment;
to execute the processing codes excluding the processing code group for the screen processing in the program upon accepting processing requests from the one or more extracted processing codes contained in the processing code group for the screen processing executed by the electronic equipment; and
to transmit execution results of the processing codes, associated with the processing requests, in the program to the electronic equipment.

2. The information processing apparatus according to claim 1, wherein the processor allocates the processing code group for the screen processing with a relay program to perform communications with the processing codes excluding the processing code group for the screen processing in the program,
transmits the processing code group for the screen processing with the relay program allocated to the electronic equipment,
accepts the processing requests from the one or more extracted processing codes contained in the processing code group for the screen processing executed by the electronic equipment through the relay program, and
transmits the execution results of the processing codes, associated with the processing requests, in the program to the electronic equipment.

3. The information processing apparatus according to claim 1, wherein the processor measures a process request frequency from the one or more extracted processing codes contained in the processing code group for the screen processing,
determines a migration of the processing codes, in the program, associated with the processing requests from the processing code group for the screen processing, based on whether the processing request frequency satisfies a predetermined condition, and
transmits the processing codes, associated with the processing requests, in the program to the electronic equipment when the predetermined condition is satisfied.

4. The information processing apparatus according to claim 3, wherein the processor determines the predetermined condition from a relationship between the processing request frequency and a predetermined threshold value, and
varies the predetermined threshold value to a substantially high setting value when an operation frequency of a screen display component on a screen pertaining to the processing code group for the screen processing satisfies a predetermined condition.

5. The information processing apparatus according to claim 3, wherein the processor determines a predetermined condition from a relationship between the processing request frequency and a predetermined threshold value,
contains security level information set per processing code, in the program, associated with the processing requests from the processing code group for the screen processing, and
varies a setting value of the predetermined threshold value relatively based on the security level information.

6. The information processing apparatus according to claim 1, wherein the processor analyzes the processing codes in the program,
extracts one or more items of data described to be saved by executing the processing codes, and
generates the processing code group for the screen processing by combining the processing codes exclusive of the one or more items of data in a manner of being executable by the electronic equipment.

7. An electronic equipment comprising:
a processor configured to accept a processing code group for screen processing, the processing code group being generated by extracting one or more processing codes describing a screen of a program and by combining one or more extracted processing codes in a manner of being executable by the electronic equipment; and
to generate a screen of the program by transmitting respective processing requests concomitant with execution of the processing code group for the screen processing to an information processing apparatus, and by acquiring results of processes associated with the respective processing requests.

8. The electronic equipment according to claim 7, wherein the processor receives a relay program to perform communications with processing codes excluding the processing code group for the screen processing in the program, the relay program allocated to the processing code group for the screen processing,
transmits the respective processing requests concomitant with execution of the processing code group for the screen processing to the information processing apparatus via the relay program, and
acquires results of processes associated with the respective processing requests via the relay program.

9. The electronic equipment according to claim 7, wherein the processor receives the processing codes, in the program, associated with the respective processing requests from the processing code group for the screen processing, the processing code group being transmitted from an information processing apparatus,
measures a processing request frequency from the one or more extracted processing codes contained in the processing code group for the screen processing, and
transmits the processing codes, which have been received, in the program to the information processing apparatus, based on whether the processing request frequency satisfies a predetermined condition.

10. The electronic equipment according to claim 9, wherein the processor determines the predetermined condition from a relationship between the processing request frequency and a predetermined threshold value, and
varies the predetermined threshold value to a substantially low setting value when an operation frequency of a screen display component on a screen pertaining to the processing code group for the screen processing satisfies the predetermined condition.

11. The electronic equipment according to claim 9, wherein the processor determines a predetermined condition from a relationship between the processing request frequency and the predetermined threshold value,
contains security level information set per processing code, in the program, associated with the processing requests from the processing code group the screen processing, and
varies a setting value of the predetermined threshold value relatively based on the security level information.

12. A computer-readable recording medium having stored therein an information processing program for causing an information processing apparatus connected to an electronic equipment to execute a process comprising:
extracting one or more processing codes describing a screen of the program by analyzing processing codes in a program;
generating a processing code group for screen processing by combining one or more extracted processing codes in a manner of being executable by the electronic equipment;
transmitting the processing code group for the screen processing to the electronic equipment;
executing the processing codes excluding the processing code group for the screen processing in the program upon accepting processing requests from the one or more extracted processing codes contained in the processing code group for the screen processing executed by the electronic equipment; and
transmitting execution results of the processing codes, associated with the processing requests, in the program to the electronic equipment.

13. A computer-readable recording medium having stored therein a processing program for causing an electronic equipment connected to an information processing apparatus to execute a process comprising:
accepting a processing code group for screen processing, the processing code group being generated by extracting one or more processing codes describing a screen of a program and by combining one or more extracted processing codes in a manner of being executable by the electronic equipment;
transmitting respective processing requests concomitant with execution of the processing code group for the screen processing to the information processing apparatus;
acquiring results of processes associated with the respective processing requests; and
generating a screen of the program, based on the results of the processes.

14. An information processing method comprising:
extracting one or more processing codes describing a screen of the program by analyzing processing codes in a program;
generating a processing code group for screen processing by combining one or more extracted processing codes in a manner of being executable by the electronic equipment;
transmitting the processing code group for the screen processing to the electronic equipment;
executing the processing codes excluding the processing code group for the screen processing in the program upon accepting processing requests from the one or more extracted processing codes contained in the processing code group for the screen processing executed by the electronic equipment; and
transmitting execution results of the processing codes, associated with the processing requests, in the program to the electronic equipment.
